(19) United States
(12) Patent Application Publication
(10) Pub. No.: US 2023/0397105 A1
(43) Pub. Date: Dec. 7, 2023

(54) REDUCING RADIO UNIT POWER CONSUMPTION

(71) Applicant: CommScope Technologies LLC, Hickory, NC (US)

(72) Inventor: Michael Brobston, Allen, TX (US)

(73) Assignee: CommScope Technologies LLC, Hickory, NC (US)

(21) Appl. No.: 18/249,956

(22) PCT Filed: Sep. 23, 2021
(86) PCT No.: PCT/US2021/071563

§ 371 Date: Apr. 20, 2023

Related U.S. Application Data
(60) Provisional application No. 63/105,731, filed on Oct. 26, 2020.

(51) Int. Cl. H04W 52/02

(52) U.S. Cl. CPC H04W 52/0216; H04W 88/08

(57) ABSTRACT

A base station for reducing power consumption in a radio unit. The base station includes at least one processor configured to trigger at least one power reduction step for the radio unit based on at least one data metric for at least the base station dropping below a threshold. The at least one processor is further configured to reduce a number of frequency carriers that the radio unit wirelessly transmits on in response to the at least one power reduction step being triggered.

### CROSS-REFERENCE TO RELATED APPLICATIONS

This application claims the benefit of U.S. Provisional Patent Application Ser. No. 63/105,731 (Attorney Docket 5276 US P1/100.1925USPR) filed on Oct. 26, 2020, entitled “REDUCING RADIO UNIT POWER CONSUMPTION”, the entirety of which is incorporated herein by reference.

### BACKGROUND

Operating cost is a major factor that wireless network operators consider in order to maintain cost effective operations. Accordingly, it may be beneficial to reduce radio unit power consumption in base stations.

### SUMMARY

A base station for reducing power consumption in a radio unit. The base station includes at least one processor configured to trigger at least one power reduction step for the radio unit based on at least one data metric for at least the base station dropping below a threshold. The at least one processor is further configured to reduce a number of frequency carriers that the radio unit wirelessly transmits on in response to the at least one power reduction step being triggered.

### DRAWINGS

Understanding that the drawings depict only exemplary configurations and are not therefore to be considered limiting in scope, the exemplary configurations will be described with additional specificity and detail using the accompanying drawings, in which:

FIG. 1A is a block diagram illustrating one exemplary embodiment of a system in which the techniques described here for reducing radio unit power consumption can be used;

FIG. 1B is a block diagram illustrating another exemplary embodiment of a system in which the techniques described here for reducing radio unit power consumption can be used;

FIGS. 2A-B are block diagrams that illustrate scenarios before and after a first power reduction step is triggered, respectively;

FIG. 3 is a block diagram illustrating a digital signal processing block (DSP), an RF front end unit, and antenna in a radio unit;

FIG. 4A is a transistor characteristic curve diagram illustrating typical class A bias condition of a power transistor in a power amplifier;

FIG. 4B is another transistor characteristic curve diagram illustrating typical class A bias condition of the power transistor in the power amplifier;

FIG. 5A is a transistor characteristic curve diagram illustrating drain bias control in a power transistor operating in class A;

FIG. 5B is a transistor characteristic curve diagram illustrating gate bias control in a power transistor operating in class A;

FIG. 5C is a transistor characteristic curve diagram illustrating a combination of gate bias control and drain bias control as a function of the AC signal level;

FIG. 6A is a transistor characteristic curve diagram illustrating bias conditions in a power transistor operating in class AB;

FIG. 6B is another transistor characteristic curve diagram illustrating bias conditions in a power transistor operating in class AB;

FIG. 6C is another transistor characteristic curve diagram illustrating drain bias operation in a power transistor operating in class AB;

FIG. 7 is a block diagram illustrating a digital signal processing block (DSP) and an RF front end unit with a transmit chain that utilizes drain voltage regulation;

FIG. 8 is a transistor characteristic curve diagram illustrating variable drain bias conditions in a power transistor operating in class AB corresponding to the variable drain voltage regulation in FIG. 7;

FIG. 9 is a waveform diagram illustrating a time-domain representation of how the drain bias voltage of the transistor would be varied relative to the average power of the transmitted symbol in the configuration of FIG. 7;

FIG. 10 is a block diagram illustrating a digital signal processing block (DSP) and an RF front end unit with a transmit chain where the number of possible bias conditions for a power amplifier is limited using a bias state index block;

FIG. 11 is a flow diagram illustrating a method for reducing power consumption in a radio unit;

FIG. 12A is a circuit diagram illustrating an example metal—semiconductor field—effect transistor (MESFET) that may be used to implement a transistor with the present systems and methods; and

FIG. 12B is a circuit diagram illustrating another example MESFET with variable voltage regulators.

In accordance with common practice, the various described features are not drawn to scale but are drawn to emphasize specific features relevant to the exemplary configurations.

### DETAILED DESCRIPTION

Multiple-input multiple-output (MIMO) is a technique that uses multiple transmit antennas and/or multiple receive antennas to wirelessly transmit a signal across a wireless network, e.g., two or four antennas at the transmitter and/or the receiver. Massive MIMO utilizes an even higher number of antennas than traditional MIMO, e.g., tens or hundreds (8, 16, 32, 64, etc.) of antennas at the transmitter and/or receiver. With the deployment of massive MIMO active radios and millimeter wave radios in Third Generation Partnership Project (3GPP) Fifth Generation (5G) wireless networks, operating costs become an even more significant concern for operators. Due to the wide instantaneous bandwidths used in millimeter wave radio links, the techniques used in prior wireless network generations (such as Doherty power amplifiers, envelope track power amplifiers, and/or digital predistortion) are more difficult to implement. Instead of using only one, two, or four large power amplifiers, massive MIMO and beamforming architectures used in 5G radios rely on a large quantity of power amplifiers operating at a lower power. This makes techniques such as envelope tracking and digital predistortion more cumbersome and less efficient since these techniques rely heavily on digital signal processing. Application of this signal processing to larger quantity of power amplifiers adds a significant level of complexity to the system. The net result is that the power amplifier efficiencies achieved in massive MIMO and millimeter wave beamforming radios is typically lower in 5G radios than were achieved in 3GPP Fourth Generation (4G) radios having two or four larger power amplifiers. Since the power amplifier efficiency is a major factor in the overall radio power consumption, this has a direct impact on the base station power consumption.

An additional factor in radio power consumption is the increased power consumption in the digital signal processing block of the radio in 5G. Whereas prior wireless network generations required signal processing in the radio for only two or four MIMO paths, massive MIMO radio are required to process signals in many more MIMO paths, e.g., 64. Whereas LTE processed channels that were typically 20 to 40 MHz in combined bandwidth, 5G networks can have a combined bandwidth of 400 to 800 MHz. This increased signal processing bandwidth requirement and the demand for a much greater number of MIMO paths can also have a dramatic impact on the power consumption of the wireless infrastructure radios. The net effect of these differences on power consumption is that 5G radios can consume up to 4 to 5 times as much power as 4G radios.

While network operators can provide higher throughput using 5G networks, the associated increase in radio power consumption in 5G radios is undesirable. During off-peak times of the day or night, it is unnecessary to provide the high throughput capability. As such, it would be advantageous (in terms of operating expense) to have the capability to reduce the power consumption of the radio equipment even at the expense of throughput capability.

Accordingly, the present systems and methods comprise a series of steps that may be taken in the radio configuration (e.g., of a 5G base station) to incrementally reduce power consumption by shutting down radio resources in response to reduced throughput demand. The sequence of these steps could be implemented in any order or all at once as the traffic demand decreases, though particular orders of steps may be used as examples herein. Additionally, the steps described herein could be used in any combination with anywhere from one to all being used in a particular radio unit.

As used herein, the term “traffic” can refer to downlink data intended sent to a user (e.g., transmitted by a radio unit in a base station using the physical downlink shared channel (PDSCH)) or uplink data sent from the user (e.g., transmitted by a UE using the physical uplink shared channel (PUSCH)). Generally, but without limitation, the term traffic does not refer to overhead/control messages, e.g., transmitted on the physical uplink control channel (PUCCH) or the physical downlink control channel (PDCCH).

### Example 5G System

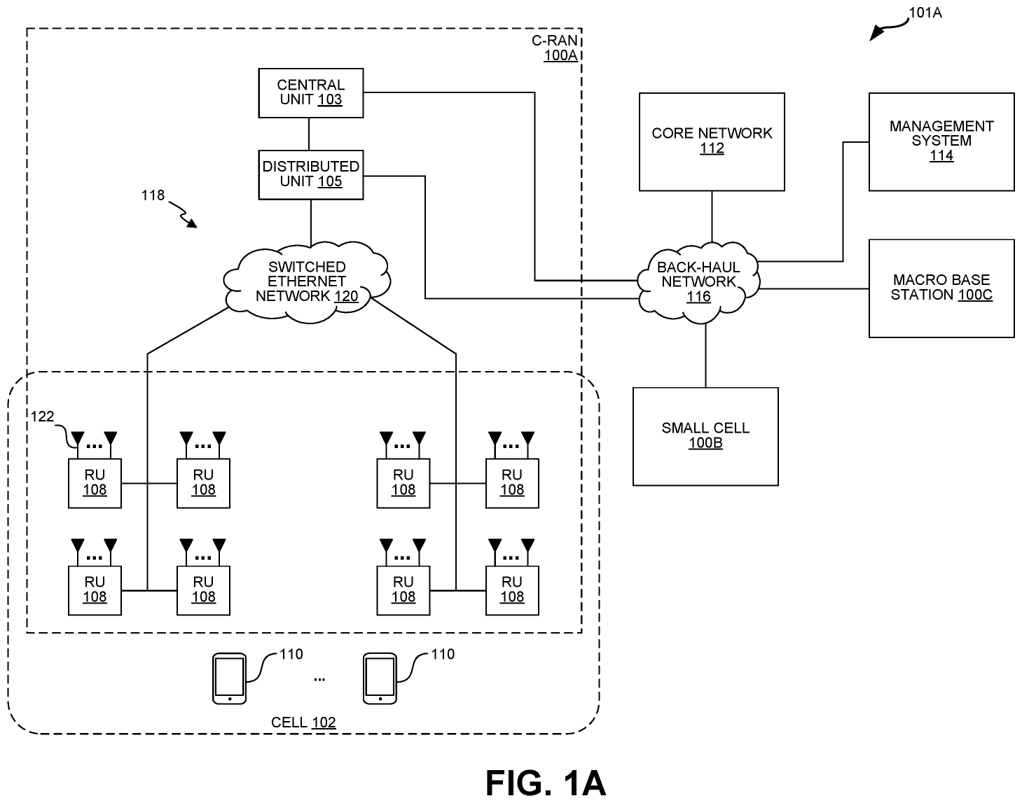

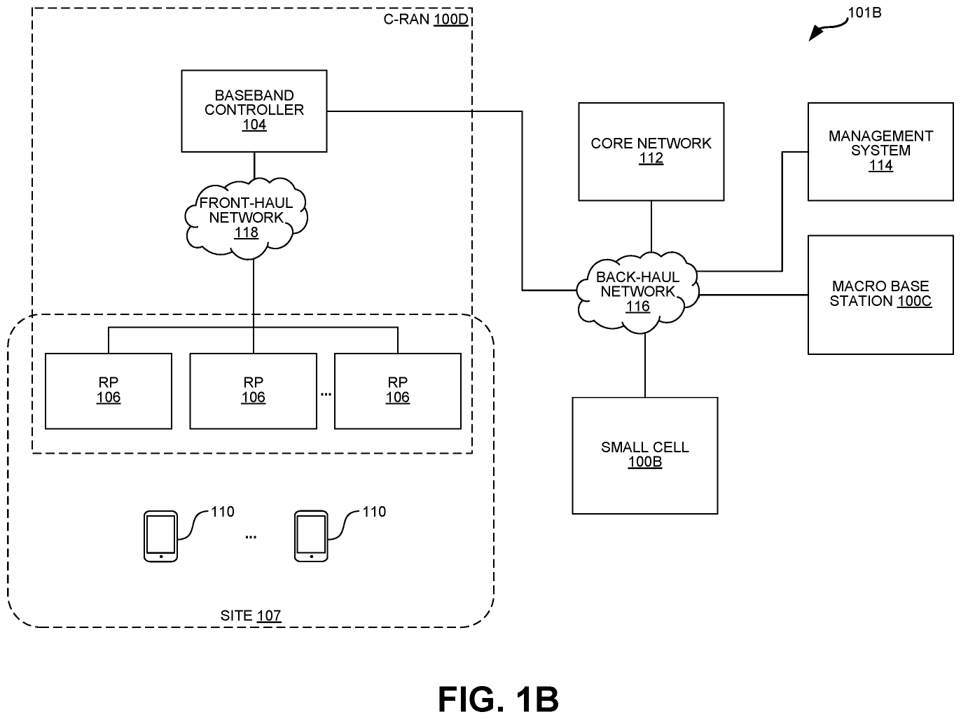

FIG. 1A is a block diagram illustrating one exemplary embodiment of a system 101A in which the techniques described here for reducing radio unit power consumption can be used. The system 101A includes one or more base stations 100. The term base station 100 herein refers to any electronic device configured to receive and transmit RF signals to provide wireless service to user equipment (UEs) 110. Typically, base stations 100 are in a fixed location, however other configurations are possible.

In the exemplary embodiment shown in FIG. 1A, one of the base stations 100A is implemented using a centralized or cloud RAN (C-RAN) architecture that employs, for each cell (or sector) 102 served by the base station 100A, the following logical nodes: at least one control unit (CU) 103, at least one distributed unit (DU) 105, and multiple radio units (RUs) 108. Each RU 108 is remotely located from each CU 103 and DU 105 serving it. Also, in this exemplary embodiment, at least one of the RUs 108 is remotely located from at least one other RU 108 serving that cell 102.

Without limitation, types of base stations include a cloud radio access network (C-RAN) 100A, a small cell 100B, a macro base station 100C, etc. Small cells 100B are generally lower-power, shorter-range, and can serve fewer max concurrent users than macro base stations 100C. For example, small cell(s) 100B may be used to fill in coverage gaps in macro base station 100C coverage, e.g., indoors, in urban environments, etc. In some cases, a C-RAN 100A may be considered a type of small cell 100B. It should be noted that the present systems and methods may be implemented using any number of C-RANs 100A, other types of small cells 100B, and/or macro base stations 100C.

The C-RAN 100A can be implemented in accordance with one or more public standards and specifications. In some configurations, the C-RAN 100A is implemented using the logical RAN nodes, functional splits, and front-haul interfaces defined by the O-RAN Alliance. In such an O-RAN example, each CU 103, DU 105, and RU 108 can be implemented as an O-RAN central unit (CU), O-RAN distributed unit (DU), and O-RAN radio unit (RU), respectively, in accordance with the O-RAN specifications. That is, each CU 103 comprises a logical node hosting Packet Data Convergence Protocol (PDCP), Radio Resource Control (RRC), Service Data Adaptation Protocol (SDAP), and other control functions. In some configurations, each DU 105 comprises a logical node hosting Radio Link Control (RLC), and Media Access Control (MAC) layers as well as the upper or higher portion of the Physical (PHY) layer (where the PHY layer is split between the DU 105 and RU 108). Each RU 108 comprises a logical node hosting the portion of the PHY layer not implemented in the DU 105 (that is, the lower portion of the PHY layer) as well as implementing the basic RF and antenna functions.

Although the CU 103, DU 105, and RUs 108 are described as separate logical entities, one or more of them can be implemented together using shared physical hardware and/or software. For example, in the exemplary embodiment shown in FIG. 1A, for each cell 102, the CU 103 and DU 105 serving that cell 102 could be physically implemented together using shared hardware and/or software, whereas each RU 108 would be physically implemented using separate hardware and/or software.

Also, in the exemplary embodiment described here in connection with FIG. 1A, the C-RAN 100A is implemented as a Fifth Generation New Radio (5G NR) RAN that supports a 5G NR wireless interface in accordance with the 5G NR specifications and protocols promulgated by the 3rd Generation Partnership Project (3GPP). Thus, in some configurations, the C-RAN 100A can also be referred to as a “Next Generation Node B” 100, “gNodeB” 100, or “gNB” 100.

Each RU 108 includes or is coupled to one or more antennas 122 via which downlink RF signals are radiated to various items of user equipment (UE) and via which uplink RF signals transmitted by UEs 110 are received.

The CU 103 and/or DU(s) 105 is/are coupled to a core network 112 of the associated wireless network operator over an appropriate back-haul network 116 (such as the Internet). Also, each DU 105 is communicatively coupled to the RUs 108 served by it using a front-haul network 118. Each of the DU(s) 105 and RUs 108 include one or more network interfaces (not shown) to enable the DU(s) 105 and RUs 108 to communicate over the front-haul network 118.

In one implementation, the front-haul 118 that communicatively couples the DU(s) 105 to the RUs 108 is implemented using a switched ETHERNET network 120. In such an implementation, each DU 105 and RU 108 includes one or more ETHERNET interfaces for communicating over the switched ETHERNET network 120 used for the front-haul 118. However, it is to be understood that the front-haul 118 between each DU 105 and the RUs 108 served by it can be implemented in other ways.

Each CU 103, DU 105, and RU 108, (and the functionality described as being included therein), as well as any other device in the system 101A more generally, and any of the specific features described here as being implemented by any of the foregoing, can be implemented in hardware, software, or combinations of hardware and software, and the various implementations (whether hardware, software, or combinations of hardware and software) can also be referred to generally as “circuitry” or a “circuit” or “circuits” configured to implement at least some of the associated functionality. When implemented in software, such software can be implemented in software or firmware executing on one or more suitable programmable processors or configuring a programmable device (for example, processors or devices included in or used to implement special-purpose hardware, general-purpose hardware, and/or a virtual platform). Such hardware or software (or portions thereof) can be implemented in other ways (for example, in an application specific integrated circuit (ASIC), etc.). Also, the RF functionality can be implemented using one or more RF integrated circuits (RFICs) and/or discrete components. Each CU 103, DU 105, RU 108, and the system 101A more generally, can be implemented in other ways.

As noted above, in the exemplary embodiment described here in connection with FIG. 1A, the C-RAN 100A is implemented as a 5G NR RAN that supports a 5G NR wireless interface to wirelessly communicate with the UEs 110.

More specifically, in the exemplary embodiment described here in connection with FIG. 1A, the 5G NR wireless interface supports the use of beamforming for wirelessly communicating with the UEs 110 in both the downlink and uplink directions using the millimeter wave (mmWave) radio frequency (RF) range defined for 5G NR (Frequency Range 2 or “FR2”), e.g., ranging from 24 GHz to 40 or 100 GHz. 5G NR RAN systems typically make use of fine beams and beamforming, especially when FR2 is used. To perform such beamforming, each RU 108 comprises an array of multiple, spatially separated antennas 122. When FR2 is used, the spacing of the antennas 122 in the array is on the order of several millimeters (as opposed to several centimeters as is the case when FR1 is used) and can be implemented in a convenient fashion.

Each fine beam concentrates energy in a single narrow direction, thus providing better signal quality for a UE 110 that is within that fine beam. In the downlink direction (that is, when the gNB 100 transmits to the UE 110), the directionality of the array is controlled by adjusting the phase and relative amplitude of the signal transmitted from each antenna 122 to create a pattern of constructive and destructive interference in the wavefront. In the uplink direction (that is, when the gNB 100 receives transmissions from the UE 110), the directionality of the array is likewise controlled by adjusting the phase and relative amplitude of the signal received via each antenna 122 to create a pattern of constructive and destructive interference in the resulting combined signal (which results from combining the signals received via all of the antennas 122 in the array). That is, for both downlink and uplink, each fine beam has an associated direction.

Beamforming can be done in an analog manner (for example, by applying the phase and relative amplitude weights in the RF front-end circuitry in each RU 108), in a digital manner (for example, by applying the phase and relative amplitude weights to the frequency-domain data generated for each antenna 122 for that UE 110 as a part of the lower PHY layer processing performed in each RU 108), or a combination of analog and digital beamforming (also called “hybrid”).

Although examples may be described as being implemented using FR2, it is to be understood that other frequency ranges can also theoretically be used (for example, the sub 6 Gigahertz (GHz) frequency range defined for 5G NR (Frequency Range 1 or “FR1”)).

A management system 114 may be communicatively coupled to the CU 103, for example, via the back-haul network 116. The management system 114 may send and receive management communications to and from the CU 103, which in turn forwards relevant management communications to and from the RUs 108. Additionally, the management system 114 may assist in managing and/or configuring the base stations 100. The management system 114 may be communicatively coupled to the CU(s) 103, DU(s) 105, and RUs 108, for example, via the back-haul network 116 and/or the front-haul network 118. A hierarchical architecture can be used for management-plane (“M-plane”) communications. When a hierarchical architecture is used, the management system 114 can send and receive management communications to and from the baseband controller 104, which in turn forwards relevant M-plane communications to and from the RUs 108 as needed. A direct architecture can also be used for M-plane communications. When a direct architecture is used, the management system 114 can communicate directly with the RUs 108 (without having the M-plane communications forwarded by the CU 103 or DU 105). A hybrid architecture can also be used in which some M-plane communications are communicated using a hierarchical architecture and some M-plane communications are communicated using a direct architecture. Proprietary protocols and interfaces can be used for such M-plane communications. Also, protocols and interfaces that are specified by standards such as O-RAN can be used for such M-plane communications.

### Example 4G System

FIG. 1B is a block diagram illustrating another exemplary embodiment of a system 101B in which the techniques described here for reducing radio unit power consumption can be used. FIG. 1B includes a C-RAN 100D implementing an 3GPP Fourth Generation (4G) air interface, whereas the C-RAN 100A in FIG. 1A implements a 5G air interface. However, it should be noted that a C-RAN 100, or a system 101 more generally, may implement 4G and 5G air interfaces.

The C-RAN 100D in FIG. 1B includes one or more baseband units (called baseband controller(s) 104) that interact with multiple radio points (RPs) 106. Each baseband controller 104 is coupled to the RPs over front-haul communication links or a front-haul network. Each RP 106 may include or be coupled to at least one antenna via which downlink RF signals are radiated to UEs 110 and via which uplink RF signals transmitted by UEs 110 are received. Furthermore, where an action is described as performed by a C-RAN 100D, it may be performed in the baseband controller 104 and/or at least one RP 106.

The RPs 106 and UEs 110 connected to (e.g., provided wireless service by) the C-RAN 100D may be located at a site 107. The site 107 may be, for example, a building or campus or other grouping of buildings (used, for example, by one or more businesses, governments, other enterprise entities) or some other public venue (such as a hotel, resort, amusement park, hospital, shopping center, airport, university campus, arena, or an outdoor area such as a ski area, stadium or a densely-populated downtown area). For example, the site 107 may be at least partially indoors, but other alternatives are possible.

It should be noted that the baseband controller 104 may or may not be located at the site 107 (with the RPs 106). For example, the baseband controller 104 may be physically located remotely from the RPs 106 (and the site 107) in a centralized bank of baseband controllers 104. Additionally, the RPs 106 are preferably physically separated from each other within the site 107, although they are each communicatively coupled to the baseband controller 104.

Each UE 110 may be a computing device with at least one processor that executes instructions stored in memory, e.g., a mobile phone, tablet computer, mobile media device, mobile gaming device, laptop computer, vehicle-based computer, a desktop computer, etc. It should be noted that any number of UEs 110 (e.g., 1-1,000) may be present at the site 107.

The C-RAN 100D may be coupled to the core network 112 of each wireless network operator over an appropriate back-haul network 116. For example, the Internet (or any other ETHERNET network) may be used for back-haul between each base station 100 and each core network 112. However, it is to be understood that the back-haul network 116 can be implemented in other ways.

In some configurations, the system 101 may be implemented as a Long Term Evolution (LTE) radio access network providing wireless service using an LTE air interface. In the LTE configuration, the baseband controller 104 and RPs 106 together (C-RAN 100D) may be used to implement an LTE Evolved Node B (also referred to here as an “eNodeB” or “eNB”). An eNodeB may be used to provide UEs 110 with mobile access to the wireless network operator's core network 112 to enable UE 110 to wirelessly communicate data and voice (using, for example, Voice over LTE (VoLTE) technology).

In an LTE configuration, each core network 112 may be implemented as an Evolved Packet Core (EPC) 112 comprising standard LTE EPC network elements such as, for example, a mobility management entity (MME) and a Serving Gateway (SGW) and, optionally, a Home eNodeB gateway (HeNodeB GW) (not shown) and a Security Gateway (SeGW) (not shown).

Moreover, in an exemplary LTE configuration, the baseband controller 104 may communicate with the MME and SGW in the EPC core network 112 using the LTE S1 interface and communicates with eNodeBs using the LTE X2 interface. For example, the baseband controller 104 can communicate with a macro base station 100C via the LTE X2 interface.

The baseband controller 104 and RPs 106 can be implemented to use an air interface that supports one or more of frequency-division duplexing (FDD) and/or time-division duplexing (TDD). Also, the baseband controller 104 and the RPs 106 can be implemented to use an air interface that supports one or more of the multiple-input-multiple-output (MIMO), single-input-single-output (SISO), and/or beam forming schemes. For example, the baseband controller 104 and the RPs 106 can implement one or more of the LTE transmission modes. Moreover, the baseband controller 104 and the RPs 106 can be configured to support multiple air interfaces and/or to support multiple wireless operators.

In some configurations, the front-haul network 118 that communicatively couples each baseband controller 104 to the one or more RPs 106 is implemented using a standard ETHERNET network. However, it is to be understood that the front-haul network 118 between the baseband controller 104 and RPs 106 can be implemented in other ways. The front-haul network 118 may be implemented with one or more switches, routers, and/or other networking devices.

Data can be front-hauled between the baseband controller 104 and RPs 106 in any suitable way (for example, using front-haul interfaces and techniques specified in the Common Public Radio Interface (CPRI) and/or Open Base Station Architecture Initiative (OBSAI) family of specifications).

The Third Generation Partnership Project (3GPP) has adopted a layered model for the LTE radio access interface. Generally, the baseband controller 104 and/or RPs 106 perform analog radio frequency (RF) functions for the air interface as well as digital Layer-1 (L1), Layer-2 (L2), and/or Layer-3 (L3), of the 3GPP-defined LTE radio access interface protocol, functions for the air interface. In some configurations, the Layer-1 processing for the air interface may be split between the baseband controller 104 and the RPs 106, e.g., with L2-L3 functions for the air interface being performed at the baseband controller 104.

Where functionality of a 5G CU 103 or 5G DU 105 is described herein, it may also equally apply to a baseband controller 104 in 4G configurations. Similarly, where functionality of a 5G radio unit (RU) 108 is described herein, it may also be implemented an RP 106 in 4G configurations. Additionally, where functionality of a radio unit (RU) 108 is described herein, it may also be implemented in a macro base station 100C or other type of small cell 100B.

Power Reduction Techniques

As discussed above, operating costs are a significant consideration for 5G network operators. Specifically, 5G network infrastructure may consume significantly more power than similar 4G network infrastructure. In an effort to reduce power consumption in radio units (RUs) 108, one or more power reduction steps may be implemented during hours of light user traffic or no traffic, e.g., very early in the morning or late at night. The power reduction step(s) described herein can be performed in any sequence or combination. Therefore, the modifiers “first,” “second,” “third,” “fourth,” and “fifth” should not be interpreted as requiring an order of the steps relative to each other, e.g., the second step may be performed before or after the first step. Furthermore, one or more of the steps described herein may not be performed at all in some configurations.

Power reduction step(s) may be triggered based on data metric(s) measured in a system 101. The data metric(s) may be determined specifically for power reduction purposes or may already be used for other purposes. Additionally, the data metric(s) may be determined periodically in some configurations. For example, downlink and/or uplink peak or average data rates for one or more base stations 100 in a system 101 may be used, e.g., downlink and/or uplink throughput in units of Mbps. In response to one or more data metrics falling below a threshold, one or more power reductions steps may be activated in one or more radio units 108, e.g., power reduction step(s) is/are triggered in response to downlink throughput for a base station 100 falling below a throughput threshold determined based on the quantity of radio resources needed to support that throughput threshold. Additionally or alternatively, power reduction step(s) may be triggered based on the current capacity (of particular base station(s) 100 or the entire system 101) being utilized, e.g., power reduction step(s) may be triggered in response to the network operating at or below 10% (or any other threshold percentage) of its downlink and/or uplink throughput capacity.

In some 5G C-RAN 100A configurations, power reduction could be triggered by the CU 103 and/or DU(s) 105 by sending message(s) across the M-plane to the RUs 108 and optionally then to the UE(s) 110, e.g., any of the messaging may include radio resource control (RRC) signaling. For example, the CU(s) 103 and/or DU(s) 105 in a C-RAN 100A may implement a set of executable instructions, which identifies situations with light user traffic or no traffic that could benefit from power reduction step(s) described herein.

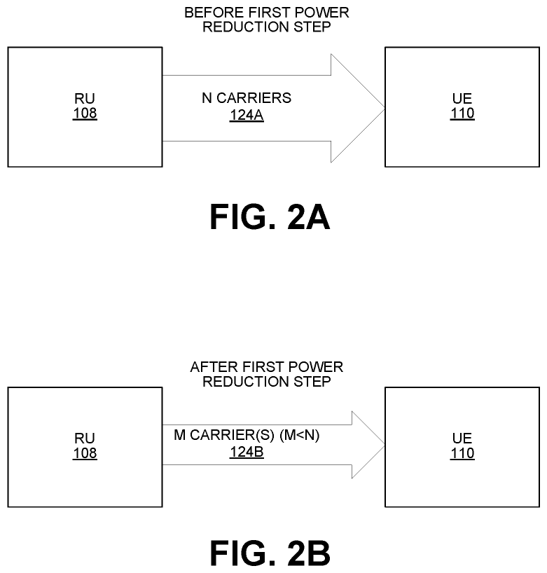

FIGS. 2A-B are block diagrams that illustrate scenarios before and after a first power reduction step is triggered, respectively. The scenarios shown illustrate the number of carriers 124A-B used by an RU 108 to communicate on the downlink to a UE 110. It is understood that the scenarios may also apply to some or all other RUs 108 in the same C-RAN 100 as the RU 108 shown. The scenarios in FIGS. 2A-B can equally apply to other types of non-C-RAN base stations 100. The number of uplink carriers 124A-B used by the UE 110 may be the same or different than the number of downlink carriers 124A-B used by the RU 108.

The first step for reducing power consumption, as traffic diminishes, is to reduce the number of carriers 124A-B transmitted by the RU 108. In configurations using sub-6 GHz bands, multiple (N) carriers 124A (e.g., of 20 to 50 MHz each) may potentially be used to provide a total instantaneous bandwidth, e.g., of 100 to 200 MHz. In millimeter wave radio configurations, multiple (N) carriers 124A (e.g., of 50, 100, 200, or 400 MHz each) may potentially be used to provide a total instantaneous bandwidth, e.g., of 1400 MHz. During peak traffic hours, it may be necessary to provide all available carriers 124A-B to meet user demand. Once power reduction is triggered in response to traffic diminishing, downlink and/or uplink data traffic may be consolidated on fewer carriers 124A-B and the unused carriers 124A-B may be disabled. For example, where the RU 108 is using N carriers 124A before the first power reduction step is triggered (in FIG. 2A), it may use only M carrier(s) 124B while the first power reduction step is implemented (in FIG. 2B). As a result, the signal processing chains (circuitry) for processing each of the disabled carriers 124A-B in the RU 108 would also be disabled, thereby reducing the power consumption in signal processing block(s) in the RU 108. For example, in an 8-carrier network, the reduction in carrier 124A-B count may progress from 8 carriers 124A-B to 7, 6, 5, 4, 3, 2 and finally to the point of having only one active carrier 124A-B within the cell 102.

In C-RAN 100 examples, all RUs 108 (or RPs 106) on the same physical cell identifier (PCI) would need to use the same number of carriers, but a first set of RUs 108 (or RPs 106) on a first PCI could use a different number of carriers than a second set of RUs 108 on a different PCI. For example, two different C-RANs 100 in the same system 101 (with the same operator) may use different PCIs and could, therefore, use a different number of carriers. More generally, in some examples, all base stations 100 (or RUs 108 or RPs 106) on the same PCI may be required to use the same number of carriers, but base stations 100 (or RUs 108 or RPs 106) on different PCI(s) could use different number of carriers.

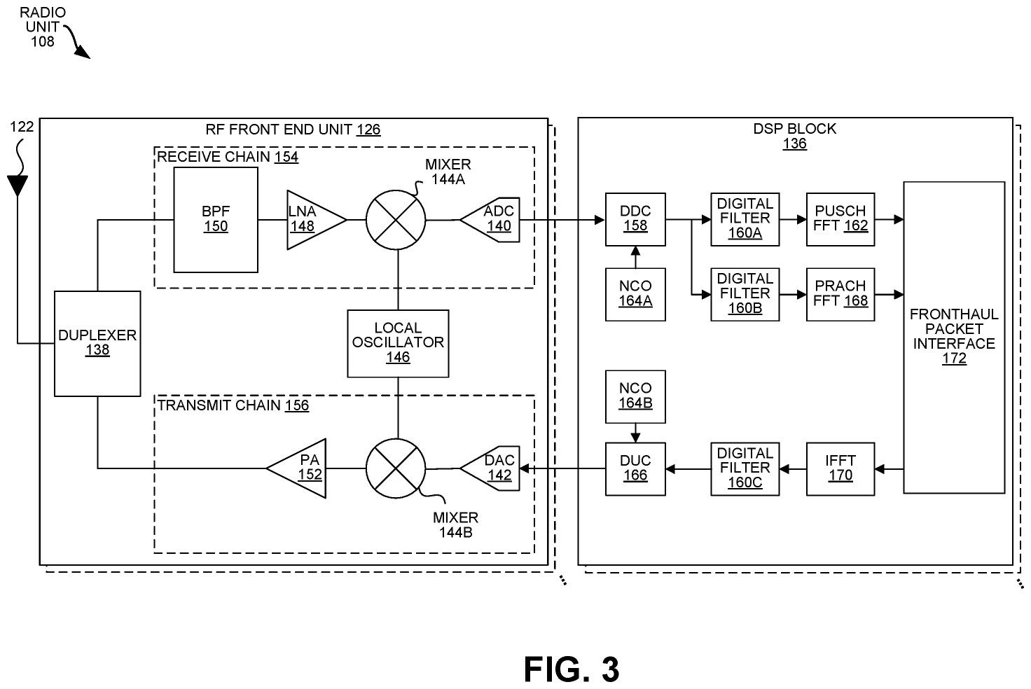

FIG. 3 is a block diagram illustrating a digital signal processing block (DSP) 136, an RF front end unit 126, and antenna 122 in a radio unit 108. The radio unit 108 may communicate with one or more DUs 105 and/or CUs 103 (e.g., via a front-haul network 118) and one or more wireless devices 110 (e.g., via an air interface). In some configurations, the radio unit 108 includes additional RF front end units 126 (not shown), each with at least one respective antenna 122. For example, if the RU 108 were using 8-column massive MIMO, the RU 108 may have eight RF front end units 126, each with a respective antenna 122. Alternatively, the RU 108 may have less RF front end units 126 than antennas 122 with at least one of the RF front end units 126 having processing signals for more than one antenna 122. In some configurations, each RF front end unit 126 may have an associated one or more digital signal processing block(s) 136, as shown in FIG. 3.

The digital signal processor(s) 136 may send signals intended for UEs 110 to the RF front end unit 126 and receive UE signals from the RF front end unit 126. For example, the digital signal processor 136 may perform processing (including digital signal processing), along with the RF front end unit 126, to convert a baseband signal (e.g., from one or more DUs 105 and/or CUs 103) into an RF signal that is radiated from one or more antennas 122 that are connected to the RF front end unit 126. In some configurations, the digital signal processor 136 may perform processing for an air interface (e.g., a 5G air interface) that is not performed in the DU 105 or CU 103, e.g., at least some of the physical layer (L1) processing. Each of the at least one digital signal processor 136 may be an FPGA, ASIC, microprocessor, DSP, etc.

The RF front end unit 126 and/or digital signal processor(s) 136 may include a receive chain 154 and a transmit chain 156. It is understood that the receive chain 154, transmit chain 156, and DSP 136 configurations illustrated in FIG. 3 are merely examples, and other configurations for an RF front end unit 126 and/or DSP 136 may be used.

The receive chain 154 may include circuitry configured to filter, mix amplify, and/or digitize analog signals received from wireless devices 110 (via one or more antennas 122) and pass them to the digital signal processor(s) 136. Specifically, an RF analog signal may be received wirelessly at the one or more antennas 122 connected to the RF front end unit 126 and fed to a duplexer 138. The duplexer 138 may be configured to selectively enable a signal from the antenna 122 to pass through the receive chain 154 or a signal from the transmit chain 156 to pass through to the antenna 122, but not both at the same time. In this way, the duplexer 138 may minimize interference between signals in the receive chain 154 and the transmit chain 156 and enable the receive chain 154 and the transmit chain 156 to share the same one or more antennas 122. The duplexer 138 may be implemented using one or more switches, filters or other circuitry configured to select between different signal paths. A band-pass filter (BPF) 150 in the receive chain 154 may be configured to filter the received analog signal to prevent out-of-band signals from propagating through the receive chain 154, i.e., frequency components above and below a particular frequency band may be attenuated or eliminated by the BPF 150 while the components in a desired frequency band remain unattenuated (or minimally attenuated). The output of the BPF 150 may be fed into a low-noise amplifier 148 that may be configured to amplify the output of the BPF 150. A first mixer 144A may then be configured to mix the output of the LNA 148 with a sinusoidal signal from a local oscillator 146, e.g., to downconvert the output of the LNA 148 from the RF band of the received signal to an intermediate frequency (IF) band. An analog-to-digital converter (ADC) 140 may be configured to digitize the mixed signal before sending to the digital signal processor(s) 136.

The digital signal processor(s) 136 may include uplink circuitry configured to process digital data received from the receive chain 154. The uplink circuitry may include a digital down-converter (DDC) 158 may digitally downconvert samples from the ADC 140; a first digital filter 160A that removes all frequencies, except the PUSCH frequencies, from the downconverted samples; and a PUSCH Fast Fourier Transform (FFT) block 162 that performs FFT processing on the remaining PUSCH time-domain samples to produce frequency-domain PUSCH baseband data encapsulated in IP packets. The frequency-domain PUSCH data is transmitted across a front-haul interface 118 by a front-haul packet interface 172 for higher level processing. A similar process is performed in parallel for received physical random access channel (PRACH) data. Specifically, a second digital filter 160B removes all frequencies, except the PRACH frequencies, from the downconverted samples from the DDC 158; and a PRACH Fast Fourier Transform (FFT) block 168 performs FFT processing on the remaining PRACH time-domain samples to produce frequency-domain PRACH baseband data encapsulated in IP packets. The frequency-domain PRACH data is transmitted across the front-haul interface 118 by the front-haul packet interface 172 for higher level processing. The DDC 158 may utilize a sinusoidal waveform generated by a digitally controlled oscillator (NCO) 164A.

The digital signal processor(s) 136 may include downlink circuitry configured to process digital data received from the front-haul packet interface 172 (via the front-haul interface 118) before sending digital data to the RF front end unit 126 for RF processing. Specifically, the inverse FFT (iFFT) block 170 may convert frequency-domain baseband samples (encapsulated in IP packets) from the front-haul packet interface 172 into time-domain samples. A third digital filter 160C may remove any out-of-band remnants introduced by the iFFT 170. A digital up conversion (DUC) 166 may then digitally upconvert the filtered time-domain samples before sending to the RF front-end unit 126. The DUC 166 may utilize a sinusoidal waveform generated by a digitally controlled oscillator (NCO) 164B, which may be the same or different as the NCO 164A utilized by the DDC.

The transmit chain 156 may include circuitry configured to convert digital signals received from the digital signal processor(s) 136, then mix and amplify the analog signals before they are transmitted to one or more UEs 110 (via the one or more antennas 122). A digital-to-analog converter (DAC) 142 may be configured to convert a digital signal from the digital signal processor(s) 136 to an analog signal, which is then fed into a second mixer 144B. The second mixer 144B may then be configured to mix the output of the DAC 142 with a sinusoidal signal from the local oscillator 146, e.g., to upconvert the output of the DAC from an intermediate frequency (IF) band to an RF band. The analog RF signal may then be input into a power amplifier (PA) 152 that may be configured to increase the power of the signal before transmitting to one or more wireless devices 110 via the one or more antennas 122.

The second step for reducing power as traffic diminishes is to shut down a component or combination of components in the RF front end unit 126 and the associated digital signal processor(s) 136. For example, any of the following groupings of components may be disabled during implementation of the second step: (1) the entire receive chain 154 and/or entire transmit chain 156; (2) merely the low-noise amplifier 148 and/or power amplifier 152 may be shut down in a subset of RF front end units 126 for a radio unit 108; or (3) any combination of components in the receive chain 154 and/or transmit chain 156. For example, in an 8 column massive MIMO system (where “column” refers to the number of antenna elements 122 in an antenna array serving the RU 108), a beamformer includes an antenna array with multiple antenna elements 122, each one phased to steer the beam. As the array size is decreased, the effective beam width increases and the Effective Isotropic Radiated Power (EIRP) decreases. The advantage of a larger array is that it provides more spatial discrimination (more capacity for spatial multiplexing) because the beam width to each UE 110 is narrower, and there are more opportunities to reuse those same resources within the same sector if there are more MIMO channels enabled. If you have very few UEs 110 being served, there may not be a need to keep all those MIMO channels enabled to provide a very narrow beamwidth and reuse those resources. So, some of those antenna elements 122 may be disabled and the radio unit 108 operates using a smaller array of antennas 122 to serve a smaller number of UEs 110 with a lower level of reuse. Therefore, by shutting off one or more of the columns, power consumption is reduced in the radio unit 108. This clearly would have an impact on the effective isotropic radiated power and sensitivity of the remaining active antenna(s) 122, but this should be tolerable to some extent during low traffic periods due to the reduction in interference from adjacent cells 102. In a millimeter wave beamforming system consisting of multiple beamforming arrays, each processing a separate MIMO channel, the second step could be implemented by shutting off one or more complete arrays and leaving only one array (and hence one MIMO channel) would be left operational. Since the power amplifiers (e.g., LNA 148 and/or PA 152) of the RF front end unit 126 may be responsible for more than half of the total radio power consumption, this technique would result in significant power reduction.

A third step for power reduction is to gate the power of one or more transmit chains 156 (including digital signal processing block 136 functions), one or more receive chains 154 (including digital signal processing block 136 functions), and/or one or more power amplifiers (e.g., LNA 148 and/or PA 152) in the radio unit 108 so they are active only (1) during slots containing synchronization signal block (SSB) traffic on the downlink; (2) during random access channel (RACH) periods on the uplink; and/or (3) whenever uplink or downlink traffic (data) is scheduled. The transmit chain(s) 156 in radio unit 108 (that haven't been deactivated in the second step for a longer term) would need to be active during the SSB slots for network synchronization and base station detection, but the active SSB periods represents a relatively small fraction of the total transmit time of the radio unit 108 if no downlink traffic is present. Similarly, the receive chain(s) 154 would need to remain active during the RACH periods to detect an access request from a user but could be powered down when no uplink traffic was present. The receive chain(s) 154 typically do not dissipate a large amount of power relative to that consumed by the transmit chain(s) 156, but there is still some gain achievable by time-gating receive chain(s) 154.

In the absence of any traffic, those overhead channels (SSB and PRACH) may be the only ones operating. By powering off the receive chain(s) 154, transmit chain(s) 156, associated digital signal processing block 136 functions, and/or power amplifiers in the radio unit 108 outside of the active SSB and RACH periods, a significant reduction in radio power consumption may be achieved. During these periods when the receive chain(s) 154 and transmit chain(s) 156 are disabled while the third step is implemented, the digital signal process block of the radio unit 108 (e.g., in the digital signal processor(s) 136) would also be disabled except during downlink SSB or uplink RACH periods thereby further reducing power consumption.

The third step is different than the second step because the receive chain(s) 154, transmit chain(s) 156, associated digital signal processing block 136 functions, and/or power amplifiers are not completely disabled in the third step. For example, in the second step, certain receive chain(s) 154, transmit chain(s) 156, associated digital signal processing block 136 functions, and/or power amplifiers may be disabled for relatively long periods of time, e.g., minutes or hours. In contrast, in the third step, certain receive chain(s) 154, transmit chain(s) 156, associated digital signal processing block 136 functions, and/or power amplifiers can transition from active to inactive and back to active multiple times per second.

In one example, a system 101 might, during light traffic, utilize the second step where the radio unit 108 entirely disables one or more antennas 122 and associated receive chain(s) 154, transmit chain(s) 156, associated digital signal processing block 136 functions, and/or power amplifiers because there is no need to keep the current number of MIMO channels enabled. The antenna(s) 122 disabled in the second step (and their associated receive chain(s) 154, transmit chain(s) 156, associated digital signal processing block 136 functions, and/or power amplifiers) would no longer operate until the second step was removed. Then, if the system 101 transitioned to a scenario with no traffic, the third step might be used for further reduction in power consumption (in addition to the second step) where remaining receive chain(s) 154, transmit chain(s) 156, associated digital signal processing block 136 functions, and/or power amplifiers are shut down except for SSB and RACH periods as described above. So the third step is particularly useful to reduce power consumption when there is no traffic without completely disabling the receive chain(s) 154, transmit chain(s) 156, associated digital signal processing block 136 functions, and/or power amplifiers, e.g., in case a user requested a radio channel.

A fourth step for power reduction is to use average power drain control on the power amplifier(s) in the transmit chain 156. In some configurations, the fourth step is independent of the other steps. In some configurations, the fourth step can be performed at any time and under any traffic conditions in a communication system 101. A transmit chain 156 may include one or more power amplifiers, such as a final power amplifier (e.g., PA 152), a pre-amplifier, and/or one or more driver stages. Average power drain control can be implemented as drain modulation and/or gate modulation. In either case, the average power of the signal being transmitted is detected and the drain and/or gate voltage of the final power amplifier stage, pre-amplifier, and/or driver stages is/are adjusted proportionally to the detected average amplitude of the transmit waveform. During moderate traffic periods, this would enable some amount of power reduction during the slots containing downlink traffic, thereby improving power amplifier efficiency. Since the downlink power associated with each resource block is generally constant, as more resource blocks are populated within a slot as downlink traffic increases, the average waveform power delivered to the antenna increases proportional to the increase in number of resource blocks. As traffic is decreased and fewer resource blocks are populated, then the average amplitude of the composite time-domain waveform decreases commensurately. The composite waveform of a subframe with 10% or less of the PDSCH resource blocks scheduled will have an average amplitude that is much lower that a subframe with a high percentage (80-100%) of its resource blocks scheduled. The power amplifier must be designed and scaled to handle the maximum power condition on a continuous basis by implementing a high bias condition in terms of drain voltage and quiescent drain current. Yet when operated with a waveform amplitude that is much lower than the maximum rated power, the efficiency of this power amplifier is very poor thereby wasting a significant amount of power. Operating a transmitter power amplifier (e.g., PA 152) at a high level of bias (where the waveform does not require that high of a bias) causes excess power dissipation. Accordingly, average power drain control can be added on the power amplifier(s) in the transmit chain 156 so that when transmit power is reduced below the power rating for the power amplifier(s) (e.g., if transmitting only SSBs), then the drain voltage(s) and quiescent current(s) of the power amplifier(s) could be reduced to further conserve power consumption. That can also be applied to the driver and pre-driver stages in the transmit chain 156 to bias those stages according to the scale of the waveform.

Drain modulation is a closed loop technique to reduce power consumption in a power amplifier in which the amplitude of the waveform is detected and the drain voltage is adjusted accordingly. The power can be detected on an instantaneous basis (also called envelope tracking) or on an average basis (which is called average power drain control).

In an example where a power amplifier operates in class AB mode, it is not necessary to bias the voltage on the drain at the power amplifier at its full extent when the waveform being transmitted is small. Instead, it is possible to reduce the bias voltage on the drain and, therefore, the power amplifier consumes less power when the waveform is backed off from its peak. Similarly, it is possible to effectively modulate the gate of the final stage amplifier and, therefore, reduce the bias on the power amplifier. Therefore, the fourth stage includes throttling back the output power capability (and power dissipation) of one or more power amplifiers in a transmit chain 156 when the waveform to be transmitted is smaller in amplitude than the top-end rated power for that stage.

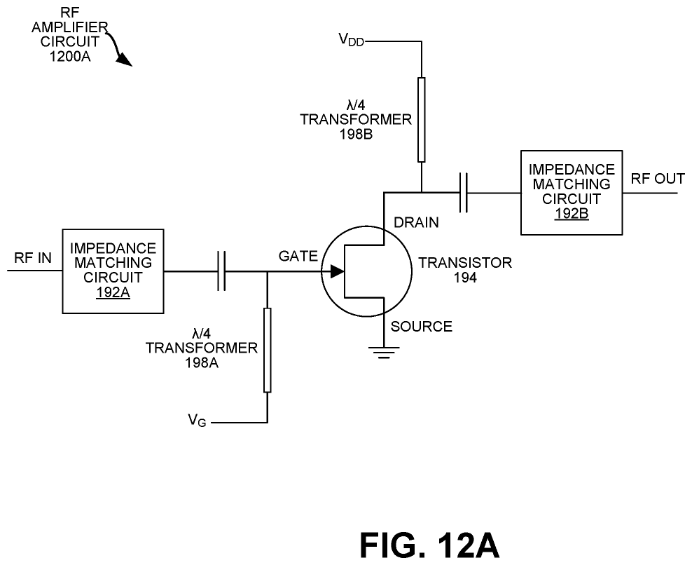

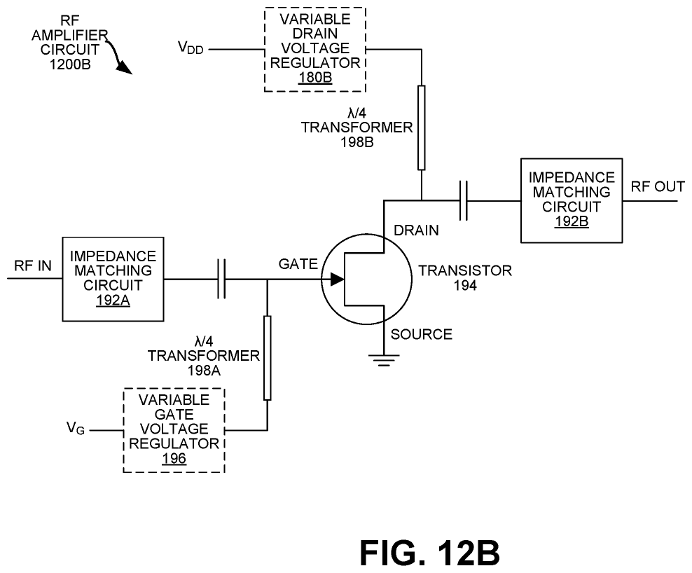

FIG. 12A is a circuit diagram illustrating an example RF amplifier circuit 1200A comprising a MESFET (e.g., GaAs) transistor 194 (also referred to as a power transistor herein). For example, the RF amplifier circuit 1200A may be located in a power amplifier, such as element 152. In the example RF amplifier circuit 1200A in FIG. 12A, the transistor 194 may receive an input at the gate and output an amplified signal at the drain, where the source is coupled to ground. The RF amplifier circuit 1200A includes impedance matching circuits 192A-B at the transistor input (gate) and output (drain) to best match the source and load impedance of the transistor 194 to optimize either the circuit 1200A gain, output power, or linearity depending on the specific requirements. A gate bias voltage, V_{G}, is applied to the gate of the transistor 194 through a quarter-wavelength transmission line 198A (quarter-wave transformer for impedance transformation) to prevent the low DC impedance of the V_{G} source from loading the high frequency RF response. Likewise, a drain bias voltage, V_{DD}, is applied to the transistor drain through a quarter-wavelength transmission line 198B (quarter-wave transformer for impedance transformation) to prevent the low DC impedance of the V_{DD} source from loading the high frequency RF response. In the circuit 1200A of FIG. 12A, the gate voltage and drain voltage as set to fixed voltage levels. The gate voltage, V_{G}, is set based upon whether the circuit 1200A is set for Class A or Class AB operation.

FIG. 12B is a circuit diagram illustrating another example RF amplifier circuit 1200B comprising a MESFET (e.g., GaAs) transistor 194. In contrast to FIG. 12A, the example RF amplifier circuit 1200B in FIG. 12B implements a variable drain voltage regulator 180B and/or a variable gate voltage regulator 196. Specifically, in the circuit 1200B of FIG. 12B, the fixed gate and drain voltages are replaced with variable voltage regulators 180B, 196 having a fixed primary voltage and a control interface used to adjust the secondary voltage to variable states. The variable secondary voltage (output of the variable drain voltage regulator 180B) is then applied to the transistor drain to implement drain bias control. Similarly, the variable secondary voltage (output of the variable gate voltage regulator 196) is then applied to the transistor gate to implement gate bias control. Although the example RF amplifier circuit 1200B is based on a type of field-effect transistor (MESFET), this same technique is directly applicable to bipolar junction transistors (BJT). In the case of a BJT, the drain and references to drain, drain voltage and drain current would be replaced with the collector, collector voltage, and collector current, respectively. Likewise, references to gate, gate voltage, and gate current would be replaced with the base, base voltage, and base current, respectively in a BJT. Similarly, references to source, source voltage, and source current would be replaced with the emitter, emitter voltage, and emitter current, respectively in a BIT.

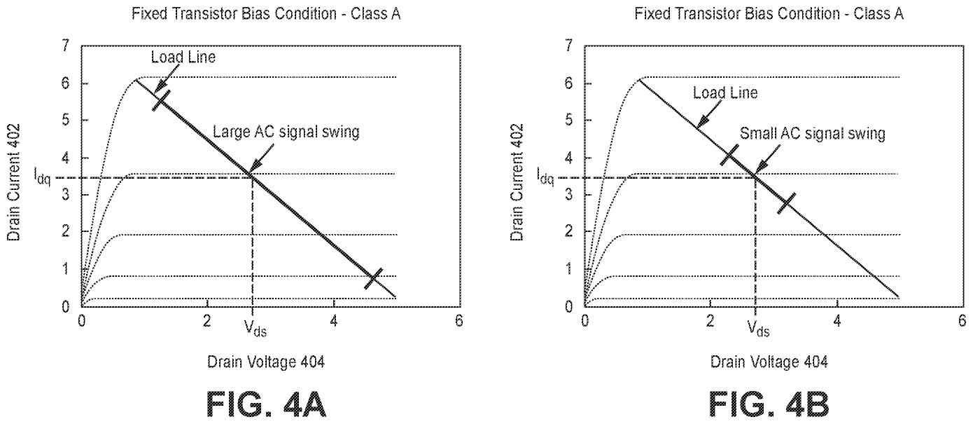

By way of illustration, and without limitation, FIGS. 4A-6C illustrate different bias conditions and operation for a respective power transistor (in a respective power amplifier). Specifically, each of FIGS. 4A-6C illustrates transistor characteristic curve diagram, which plots drain current (I_{dq}) 402 as a function of drain voltage (V_{ds}) 404. For example, each of the curves in a particular transistor characteristic curve diagram may represent operation of the power transistor at different gate-source voltages in a transistor, such as a metal—semiconductor field—effect transistor (MESFET). Therefore, where a drain, gate, or source are referred to below, they may refer to terminals on one or more transistors (e.g., MESFET(s)) in a power amplifier, such as PA 152. Additionally, the term “power transistor” refers to a transistor in a power amplifier, such as PA 152. Furthermore, any “block” (such as a DSP block 136) described below may be implemented using circuitry and/or instructions executed by at least one processor. Additionally, the term “bias” herein refers to a fixed direct current (DC) voltage applied to a terminal of a power transistor, which can determine which region the power amplifier operates in, e.g., nonlinear or linear. Typically, a bias voltage is applied to the gate or the drain terminal in MESFET configurations, but other configurations are possible.

FIG. 4A is a transistor characteristic curve diagram illustrating typical class A bias condition of a power transistor in a power amplifier. In a class A bias condition, the quiescent DC current of the transistor is set by applying a certain gate voltage to bias the transistor such that it conducts current through the complete waveform cycle. Fundamentally, this DC bias condition is necessary since an AC waveform alternately conducts current in both directions whereas a transistor only conducts current in one direction across its drain-source junction. As an example, if a sinusoidal waveform of the maximum rated amplitude is applied to the power amplifier circuit (e.g., in FIG. 12A or 12B), the transistor will conduct current through the full 360 degrees of the sinusoidal waveform cycle without entering either the saturation or cut-off region of the transistor. The class A bias condition provides excellent linearity, yet very poor drain efficiency since it requires a significant DC current through the transistor at all times. The DC power in this bias current is dissipated completely by the transistor and bias network since it cannot be delivered to the load. Therefore, it is wasted power consumption.

Alternately, a class AB bias condition sets the quiescent bias current of the transistor slightly higher than the transistor cut-off condition. In this bias condition, the transistor conducts for less than the full 360 degree of the waveform cycle, but typically more than 180 degrees, therefore some portion less than 50% of the waveform cycle is cut off or rectified. Rectifying a portion of the waveform has the effect of reducing linearity of the circuit, but the drain efficiency is improved relative for class A bias since much less power is consumed in the quiescent DC current since this current is set much lower than for the class A condition.

For class A bias condition, the transistor is biased with a DC voltage applied to the gate to set the center of the alternating current (AC) voltage swing to the center of load line to provide optimum linearity for waveform amplification. One problem with this technique is that the efficiency is very poor since most of the power dissipated by the transistor is a result of the DC bias condition. The wasted DC power is essentially the quiescent drain current (I_{dq}) 402 multiplied by the drain to source voltage (V_{ds}) 404. FIG. 4A illustrates a large signal condition at which the AC signal swing effectively occupies the full range of the load line. Even at this condition, the efficiency is very poor.

FIG. 4B is another transistor characteristic curve diagram illustrating typical class A bias condition of the power transistor in the power amplifier. Specifically, FIG. 4B illustrates how, with this fixed bias condition, the efficiency continues to degrade as the AC signal power decreases. This shows that the DC bias condition remains unchanged, whereas the AC signal swing occupies only a small portion of the load line resulting in a further degradation of the power added efficiency of the circuit.

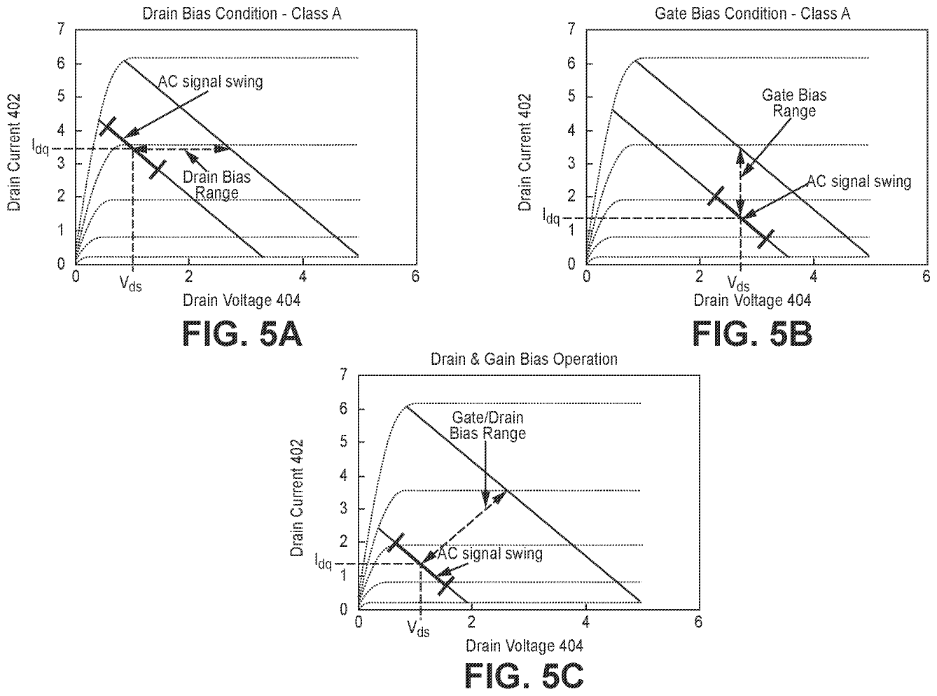

FIG. 5A is a transistor characteristic curve diagram illustrating drain bias control in a power transistor operating in class A. Specifically, FIG. 5A illustrates that under small AC signal conditions, the bias voltage applied to the transistor drain can be reduced. Since the power wasted in biasing the transistor is effectively I_{dq} 402 times V_{ds} 404, the Class A bias power is reduced due to the reduction in V_{ds} 404.

FIG. 5B is a transistor characteristic curve diagram illustrating gate bias control in a power transistor operating in class A. In this case as the AC signal swing is reduced for lower power signal transmission, the quiescent drain current (I_{dq}) 402 is reduced by reducing the gate bias voltage condition. Since the power wasted in biasing the transistor is effectively I_{dq} 402 times V_{ds} 404, the Class A bias power is reduced due to the reduction in I_{dq} 402.

FIG. 5C is a transistor characteristic curve diagram illustrating a combination of gate bias control and drain bias control as a function of the AC signal level. As the AC signal level decreases, both the gate bias and drain bias voltages can be reduced in this configuration. Since the power wasted in biasing the transistor is effectively I_{dq} 402 times V_{ds} 404, the Class A bias power is reduced due to the reduction in both V_{ds} 404 and I_{dq} 402.

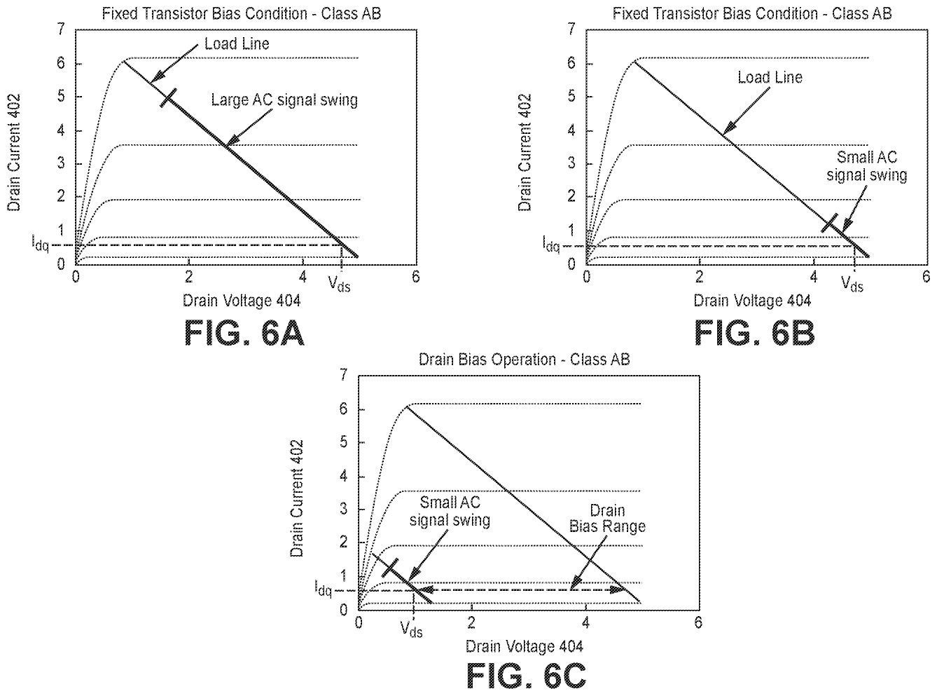

While class A bias conditions can usually provide the best linearity, a class AB bias condition is frequently used since it offers improved efficiency with acceptable linearity. FIG. 6A is a transistor characteristic curve diagram illustrating bias conditions in a power transistor operating in class AB. In FIG. 6A, the waveform is effectively partially rectified, as described above, since the quiescent drain current (I_{dq}) 402 is set to a very low condition by setting a low gate bias voltage. Under a large signal condition, as illustrated in FIG. 6A, this adjustment provides a significant improvement in power-added efficiency (compared to class A operation) since the power wasted in the DC bias conditions is reduced through a reduction in the quiescent drain current (I_{dq}) 402.

FIG. 6B is another transistor characteristic curve diagram illustrating bias conditions in a power transistor operating in class AB. FIG. 6B illustrates that, even with Class AB bias, the power-added efficiency is again very poor when transmitting at lower signal levels.

One technique to mitigate this poor efficiency is application of drain bias for Class AB power amplifiers. FIG. 6C is another transistor characteristic curve diagram illustrating drain bias operation in a power transistor operating in class AB. For small AC signal swing conditions, the drain bias voltage is reduced so that the power dissipated by the DC bias conditions, effectively I_{dq} 402 times V_{ds} 404, is minimized. As stated previously, for modulated waveforms that typically have a wide range in instantaneous power fluctuation, this can be implemented in two possible means. The first is envelope tracking in which the waveform envelope is detected and the drain voltage (V_{ds}) 404 applied to the transistor is varied synchronously with the waveform envelope variations. The disadvantage of this technique for wideband waveforms, particularly for 5G NR waveforms that can have up to a 400 MHz bandwidth, is that this requires very fast modulation of the drain voltage (V_{ds}) 404. Currently, this technique may not be practical for waveforms exceeding 40 MHz of signal bandwidth.

The second method for drain bias control is to detect the average power of the waveform and to apply a varying drain voltage (V_{ds}) 404 that is proportional to the average signal power. This technique has disadvantages in that the average waveform power can vary on a symbol by symbol basis. Therefore, the response of the power detector and drain bias voltage control circuit has to be fast (e.g., virtually instantaneous) to avoid distortion of the transmitted waveform when there are sudden steps in transmitted signal power. Determining the average amplitude of a time-domain symbol accurately would require averaging all of the symbol samples over the entire symbol duration. Accurately adjusting the drain bias based on the time-domain symbol amplitude could only be accomplished by delaying the symbol data in the signal path by at least one symbol period so that the average symbol power could be calculated first. This would allow the drain bias voltage to be set correctly at the start of the symbol period but would increase the signal path latency by at least one symbol period. The processing of time averaging the waveform sample inherently has latency that is unavoidable, yet this added latency is highly undesirable.

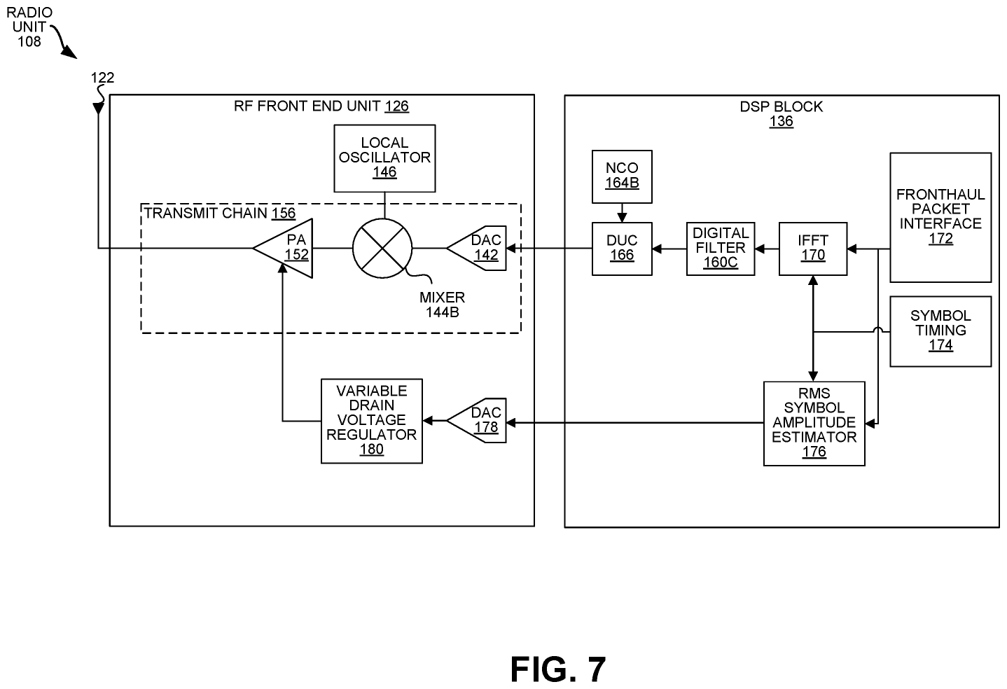

To avoid the need for extremely wideband control of the drain voltage 404 while achieving a priori control of the drain voltage 404 to avoid drain voltage 404 changes during the symbol period, the drain bias control technique of the present systems and methods takes advantage of the iFFT process that is now a feature of many 5G radios. With implementation of what is commonly known as the 7.2x front-haul split, the iFFT block of the transmitter digital signal processing chain has been moved into the radio (e.g., the RU 108 or RP 106) as a technique for reducing the front-haul 118 data rate. Because of this, the front-haul user plane data consists of complex frequency-domain samples, whereas in the past the typical Common Public Radio Interface (CPRI) or Enhanced CPRI (eCPRI) front-haul 118 transmitted complex time-domain samples. In contrast, the present systems and methods transmit frequency-domain samples across the front-haul 118, as described below in FIG. 7

FIG. 7 is a block diagram illustrating a digital signal processing block (DSP) 136 and an RF front end unit 126 with a transmit chain 156 that utilizes drain voltage regulation. It is understood that the radio unit 108 depicted in FIG. 7 may also include any of the additional elements from FIG. 3, such as a receive chain 154, even though it is not included in FIG. 7. In the present systems and methods, all of the frequency-domain samples may be loaded into the iFFT block 170 at the start of each symbol after which the sample clock 174 is then used to clock out the corresponding time-domain samples resulting from the iFFT process. This means that the full set of frequency-domain samples are available at the start of a symbol and can be used to calculate an RMS symbol amplitude (in the RMS symbol amplitude estimator 176) at the start of the symbol rather than having to average the time-domain sample amplitudes over the entire symbol period. Because of this, it is possible to calculate the average symbol amplitude at the start of the symbol, then use this amplitude to set the drain bias voltage of the power amplifier (e.g., PA 152) accordingly at the start of the symbol. This process of determining the RMS symbol amplitude at the start of a symbol allows the power amplifier drain bias voltage to be set in advance of the symbol and therefore avoid the delay in response time associated with averaging the time-domain samples. It also avoids the possibility of changing the drain bias voltage during the symbol period which would certainly degrade modulation accuracy measured in terms of EVM (error vector magnitude) and avoids the added symbol latency resulting from the need to average the symbol time-domain samples over the entire symbol period before setting the drain bias voltage.

Therefore, in the architecture illustrated in FIG. 7, the frequency-domain samples from the front-haul packet interface 172 are loaded into the RMS symbol amplitude estimator 176 coincident to being loaded into the iFFT block 170. This RMS symbol amplitude estimator 176 is then able to calculate the RMS symbol amplitude prior to the first symbol sample being clocked out of the iFFT block in the primary transmitter signal chain. This RMS symbol amplitude is used to control the Variable Drain Voltage Regulator to set drain voltage 404 of the power transistor to an appropriate level that provides acceptable linearity while minimizing the DC bias condition and the associated wasted power consumption.

FIG. 7 illustrates one example implementation in that the RMS symbol amplitude estimates from the digital signal processing block 136 are converted to the analog voltage using a DAC 178, and this analog voltage is used to control a drain voltage regulator 180A. An alternate implementation (not illustrated in FIG. 7) is to use a digitally controlled drain voltage regulator having a finite number of discrete output voltage conditions. In this case, the digital output from the RMS symbol amplitude estimator 176 would be routed directly to the digitally controlled drain voltage regulator without using the DAC 178 shown in FIG. 7.

Whether the drain voltage regulator 180A is controlled by an analog voltage (as in FIG. 7) or has digital control, there will be a finite number of discrete drain bias voltage conditions. Even in the architecture illustrated in FIG. 7, the number of discrete steps of drain voltage 404 outputs for the variable drain voltage regulator 180A would be set by the bit width of the control bus from the RMS symbol amplitude estimator 176. This drain voltage regulator 180A is effectively a switching voltage regulator to provide optimum power conversion efficiency in which the output voltage is set either by analog control (as in FIG. 7) or digital control.

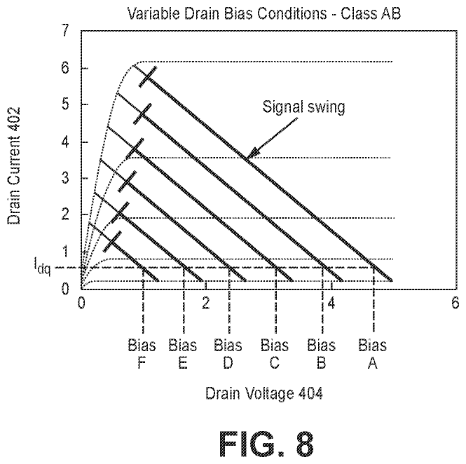

FIG. 8 is a transistor characteristic curve diagram illustrating variable drain bias conditions in a power transistor operating in class AB corresponding to the variable drain voltage regulation in FIG. 7. Under maximum signal conditions, the RMS symbol amplitude estimator 176 would calculate a high signal amplitude and set up Bias A condition on the drain. For lower and lower signal amplitude conditions calculated by the RMS symbol amplitude estimator 176, Bias B, C, D, and E voltages would be applied to the drain. Finally, for the lower signal conditions, Bias F voltage would be applied to the drain. While this illustration uses six discrete bias states, the number of bias states used can be set to any number greater than 1 for this technique and this number of states would be set to achieve the best balance between power added efficiency and power amplifier linearity.

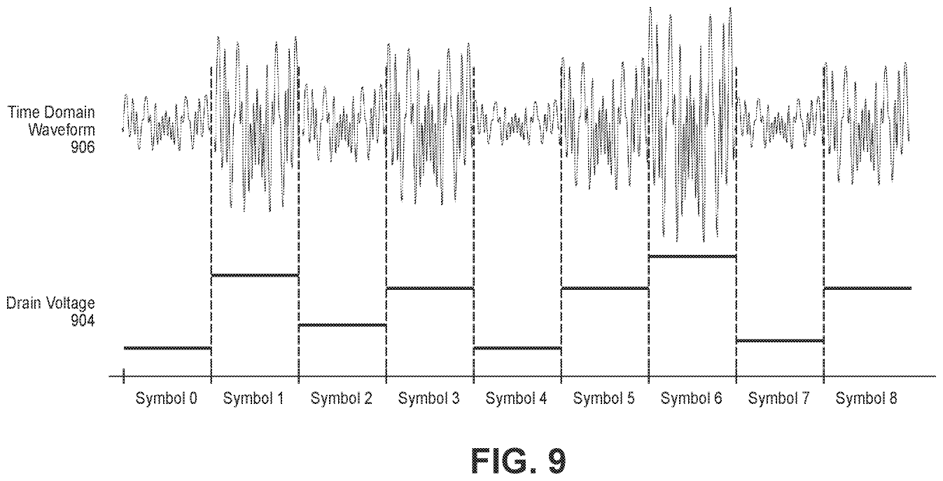

FIG. 9 is a waveform diagram illustrating a time-domain representation 906 of how the drain bias voltage of the transistor would be varied relative to the average power of the transmitted symbol in the configuration of FIG. 7. As the symbol amplitude of the time-domain waveform 906 changes, the average amplitude is calculated in advance and the drain voltage 904 is set accordingly. Using this technique, during low load conditions in which very few or none of the user plane resource blocks of the waveform 906 contain data, then the RMS symbol amplitude will be lower. For these symbols, a low bias voltage will be set to the transistor drain, e.g., as in symbols 0, 2, 4, 7. Whereas when most or all of the resource blocks of the symbols are occupied, the RMS symbol amplitude will be high. Under this condition, a high bias voltage will be set to the transistor drain, e.g., as in symbol 6. During low load conditions when potentially there is no user data traffic in the downlink, only the SSB will be transmitted. During the SSB symbols, the composite signal power transmitted is significantly lower that a fully loaded waveform and the power consumption using this technique will be significantly lower during these symbols. Then during symbols that contain neither SSB nor user traffic, the quiescent power consumption of the power amplifiers would be at its minimum. Using the symbol-based drain bias control technique applied to a class AB amplifier, the transmitter power consumption will be significantly reduced during low load or no load conditions of the wireless network. To reduce complexity in the drain voltage regulator 180A, it may be desirable to limit the number of possible bias conditions.

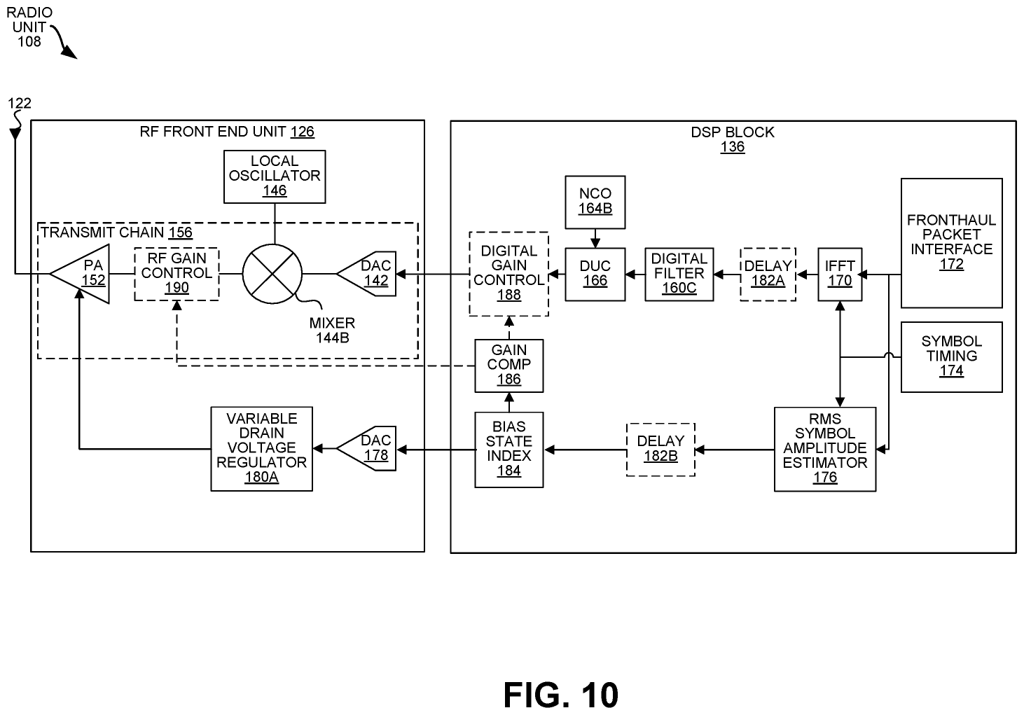

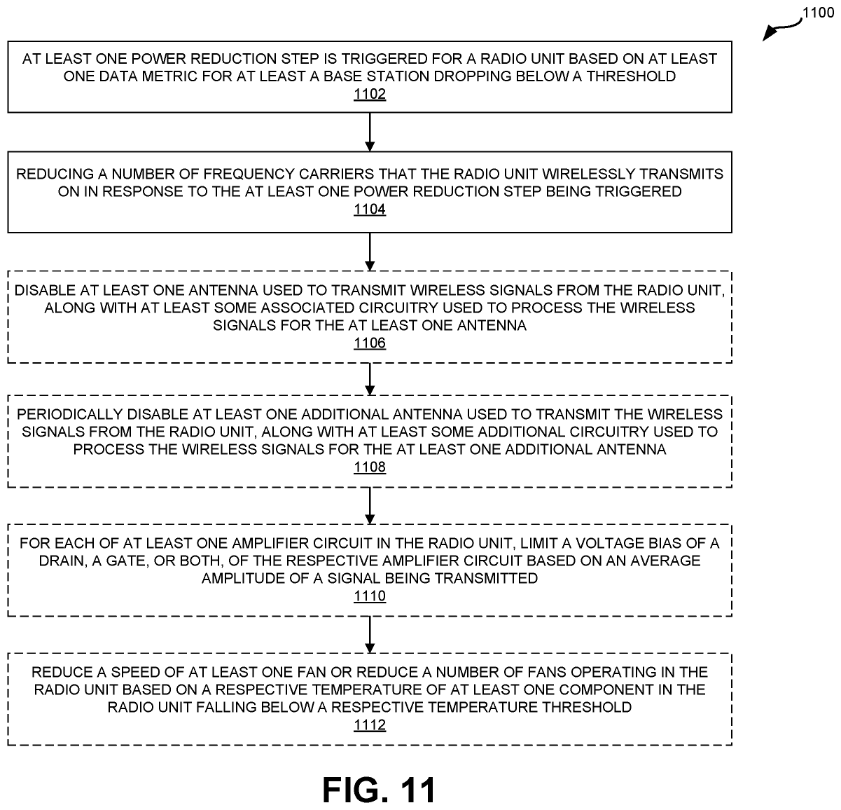

FIG. 10 is a block diagram illustrating a digital signal processing block (DSP) 136 and an RF front end unit 126 with a transmit chain 156 where the number of possible bias conditions for a power amplifier is limited using a bias state index block 184. It is understood that the radio unit 108 depicted in FIG. 11 may also include any of the additional elements from FIG. 3, such as a receive chain 154, even though it is not included in FIG. 11.

The bias state index block 184 may bin the large number of possible amplitude conditions into smaller set of bias conditions. The RMS symbol amplitude estimation process is a mathematical process could result in a very large number of possible outcomes. Assuming the input to the RMS symbol amplitude estimator 176 exceeds 100 complex sub-carrier amplitudes each having potentially 14 bits of data, the output of the RMS symbol amplitude estimator 176 may have greater than 2\hat{ }16 possible outcomes if not truncated. Since the number of possible bias condition would likely need to be managed to a smaller number (such as 30, 20, or even less than 10), some decoding and quantization of the calculated amplitude would need to be done to bin ranges of amplitudes into a finite number of discrete bias conditions. Since there is also some minimum drain voltage 404 condition that is needed by the transistor, this binning is also needed to account for specific limitation in the possible bias conditions. Therefore, the bias state index block 184 is used to convert the wide range of possible amplitude values in specific bias conditions that can be tailored to the limitations of the power transistor.

One typical side effect of changing the bias condition on a power transistor is a change in the circuit gain. Often, as the drain voltage 404 of the power transistor is reduced, there is some amount of resulting gain reduction in the circuit. It may be desirable for the transmit chain 156 to have a constant gain from symbol to symbol independent of the symbol amplitude. To mitigate the possible gain variation that could occur as the drain bias condition of the power transistor is changed, a gain compensation block 186 may be used, as illustrated in FIG. 10. The gain compensation block 186 receives the specific bias states from the bias state index block 184 and determines the amount of gain compensation needed to maintain a constant gain for all bias states. The gain compensation block 186 may be implemented as a look-up table (LUT) indexed by the bias state and the LUT would contain gain values based on a characterization of the power transistor gain under these bias states. Low bias states may correspond to higher gain values in the LUT and these higher gain settings would control the digital gain control block 188 and/or an RF gain control block 190 in increase the channel gain. Conversely, high bias states may correspond to lower gain values in the LUT, which would reduce the gain of the digital gain control block 188 and/or the RF gain control block 190 to compensate for increased power transistor gain. In one configuration, only the digital gain control block 188 or the RF gain control block 190 are needed. Alternatively, both the digital gain control block 188 and the RF gain control block 190 or it may be used in the chain to adequate compensate the gain variation resulting from bias condition changes. In configurations without the digital gain control block 188, the output of the DUC 166 may feed directly to the input of the DAC 142.

It may be desirable for the bias condition change appearing at the drain of the power transistor to be well aligned in time with the leading edge of the modulated symbol data appearing at the power transistor gate, whereas it is likely that the latency of the amplitude estimation and bias state path is different from that of the modulated signal path. Therefore, delay block(s) 182A-B may be included in the bias state control path and/or the modulated signal path. The path with the shortest latency would be delayed using a first-in first-out (FIFO) or other similar form of digital delay in order to align the modulated signal (top path in FIG. 10) and symbol-boundary bias control change (from the bottom path in FIG. 10) at the power transistor. For example, the bias control changes corresponding to a given symbol would be timed to take place at the beginning of the cyclic prefix of that symbol such that the bias change has no impact on the previous symbol. The transient response of the variable drain voltage regulator 180A and the effective drain capacitance of the power transistor would be designed so that the bias voltage change would be fully converged to the new bias condition prior to the end of the cyclic prefix thus avoiding any bias voltage changes during the symbol data period. By implementing this architecture using delay compensation and/or gain compensation as shown in FIG. 10, the modulation accuracy and linearity of the transmit chain 156 and power amplifier will be preserved while ensuring that the power amplifier is always operated efficiently.

A fifth step for power reduction would apply to RUs 108 that are actively cooled by means of an internal electrical fan. In some configurations, fan speed can be controlled by adjusting the DC voltage applied to the fan or using a pulse width modulation technique of the applied DC voltage. By providing the internal microcontroller (processor) within the RU 108 the capability to sense the internal electronic device temperatures (using a thermometer) and to control the fan speed, a closed loop approach to fan speed control can be implemented. In this technique, the temperature of at least one of the components in the RU 108 is read by the microcontroller. In many radio systems this may be the internal temperature of at least one processor (e.g., FPGA(s) or ASIC(s)), the temperature of a power supply block, or temperature of an optical small form-factor pluggable (SFP). Then by establishing at least one temperature threshold above which a high fan speed is used and below which a lower fan speed is used, then the power consumption of the fan can be reduced as the internal electronics temperature decreases. Instead of maintaining a constant fan speed at all times, which may consume for example 2 to 3 watts of power, control of the fan speed as a function of device temperature(s) can be combined with the previously-described techniques to further reduce power consumption in some configurations. As the power consumption of the RU 108 is reduced commensurately, then the internal device temperatures will also decrease. As the device temperature decreases due to the power reduction steps, then the fan speed would be reduced commensurately thereby reducing the fan power consumption. With significant reductions in power consumption (e.g., resulting from the previously-described techniques), it may also be possible to completely turn off the fan operation and rely on natural air convection to provide cooling of the radio unit. Furthermore, a combination of internal temperatures of different components may be used to trigger fan speed reduction, e.g., fan speed is reduced approximately proportional to the number of a predetermined number of RU 108 components whose internal temperatures are below a temperature threshold. Additionally, a different temperature threshold may be applied to different temperatures, e.g., a first threshold for a first processor, a second threshold for a second processor, a third threshold for the power supply block, etc.

Some RUs 108 include multiple fans. A plurality of fans may be implemented for the purpose of better distributing the air flow, for the purpose of redundancy to improve overall radio reliability, or for the purpose of enabling use of smaller, low-profile fans to minimize volume impact to the overall assembly. Therefore, in one configuration of the fifth power reduction step, the number of fans that are simultaneously running may be reduced as the temperature(s) (of processor(s), power supply block, and/or other components in the RU 108) decrease, which has the effect of reducing fan power consumption as the power consumption of the active electronics in the RU 108 decreases, e.g., following any of the previously-described step(s). For example, the normal operating mode of the RU 108 may require M out of N fans running in order to maintain the appropriate internal temperatures, where M<=N. As power consumption of the active electronics in the RU 108 is decreased, the number of fans operating simultaneously could be reduced from N down to 1 or, in very lower power consumption cases, down to 0.

The five steps described herein may be used alone or in combination. In some configurations, the steps may be implemented in a sequential fashion (first, second, third, fourth, fifth) to incrementally reduce radio unit 108 power consumption as the traffic load diminishes during off-peak network utilization periods. If applied in a particular sequence, as the traffic load increases, the steps can be removed in the reverse order they were applied in to enable increased traffic capacity through the radio unit 108.

FIG. 11 is a flow diagram illustrating a method 1100 for reducing power consumption in a radio unit 108. The method 1100 may be implemented by at least a radio unit 108 in a wireless communication system 101. The radio unit 108 be part of a C-RAN 100A implementing a 5G air interface. Alternatively, the method 1100 may be implemented by an RP 106 in a C-RAN 100D implementing a 4G air interface, a macro base station 100C, or another type of non-C-RAN small cell 100B. In some examples, at least a portion of the method 1100 is performed by at least one central unit, such as a DU 105, a CU 103, or a baseband controller 104. The entity or entities may perform the method 1100 using respective processor(s) that execute instructions stored on respective memories.

The blocks of the flow diagram shown in FIG. 11 have been arranged in a generally sequential manner for ease of explanation; however, it is to be understood that this arrangement is merely exemplary, and it should be recognized that the processing associated with method 1100 (and the blocks shown in FIG. 11) can occur in a different order (for example, where at least some of the processing associated with the blocks is performed in parallel and/or in an event-driven manner). Also, most standard exception handling is not described for ease of explanation; however, it is to be understood that method 1100 can and typically would include such exception handling.

The method 1100 begins at step 1102 where at least one power reduction step is triggered for an RU 108 based on at least one data metric for at least the base station dropping below a threshold. Power reduction step(s) may be triggered based on data metric(s) measured in a system 101. For example, a central unit may trigger the power reduction step(s) in response to downlink and/or uplink (average, peak, or other instantaneous) data rates for one or more base stations 100 in a system 101 falling below a threshold. Additionally or alternatively, power reduction step(s) may be triggered based on the current throughput (of particular base station(s) 100 or the entire system 101) being utilized, e.g., power reduction step(s) may be triggered in response to the network operating at or X % (e.g., 10%) of its throughput capacity. The throughput can be determined based on some measure of the amount of MAC level data transmitted within a given frame or subframe.

In C-RAN 100A, 100D examples, the RU 108 may be one of a plurality of RUs 108 (or RPs 106). In non-C-RAN small cell 100B or macro base station 100C examples, the base station may include a single radio. In a C-RAN 100A, 100D configuration, power reduction could be triggered by the CU 103 and/or DU(s) 105 in 5G configurations or a baseband controller 104 in 4G configurations. For example, the CU 103, DU(s) 105, or baseband controller 104 in a C-RAN 100A may be configured to identify situations with light user traffic or no traffic, which could benefit from power reduction step(s). Alternatively, the power reduction step(s) may be triggered at the RU 108 or an external management system 114. In C-RAN 100A, 100D configurations, the method 1100 may be performed in parallel for multiple or all RUs 108 in the same C-RAN 100A, 100D. In 5G configurations, message(s) can be sent, from the CU 103, DU(s) 105, or baseband controller 104, across the M-plane to the RUs 108 (or RPs 106) and, optionally, then on to the UE(s) 110, e.g., using radio resource control (RRC) signaling.

The method 1100 proceeds at step 1104 (referred to as the first step above) where the RU 108 reduces a number of frequency carriers that that the RU 108 wirelessly transmits on in response to the at least one power reduction step being triggered. Step 1104 may optionally also include the RU 108 reducing the number of frequency carriers that the RU 108 wirelessly receives information on. Reducing the number of downlink frequency carriers will reduce the total instantaneous bandwidth the RU 108 can utilize on the downlink, but reduce power that would otherwise be consumed by the circuitry (e.g., transmit chain(s) 156 and/or receive chain(s) 154) and processor 136 resources used to process the frequency carriers that are no longer being used.

The method 1100 proceeds at optional step 1106 (referred to as the second step above) where the RU 108 disables at least one antenna 122 used to transmit wireless signals from the RU 108, along with at least some associated circuitry used to process the wireless signals for the at least one antenna 122. The associated circuitry being disabled may include (1) entire receive chain(s) 154 and/or transmit chain(s) 156 processing signals for the disabled at least one antenna 122; (2) merely low-noise amplifier(s) 148 and/or power amplifier(s) 152 in the receive chain(s) 154 and transmit chain(s) 156, respectively, processing signals for the disabled at least one antenna 122; or (3) any combination of components in the receive chain 154 and/or transmit chain 156 processing signals for the disabled at least one antenna 122. For example, optional step 1106 may include reducing the number of active antennas 122 in an antenna array used by the RU 108 for MIMO communication, which may also be referred to as reducing the number of columns in a MIMO system. Instead of disabling a subset of antenna(s) 122 within an antenna array, entire antenna array(s) (and at least some associated circuitry) could be disabled in optional step 1106, e.g., in a mmWave beamforming system with multiple beamforming arrays.

Optional step 1106 may include the RU 108 disabling the at least one antenna 122 at least some minimum period of time, e.g., 1 minute, 5 minutes, 15 minutes, 30 minutes, 1 hour, 2 hours, 6 hours, 12 hours, etc. In some configurations, the at least one antenna 122 disabled in optional step 1106 remains disabled until an external message is received at the RU 108 (e.g., from a CU 103 or DU 105) instructing the RU 108 to re-enable the disabled at least one antenna 122.

Disabling antenna(s) 122 in optional step 1106 may increase effective beam width(s) and decrease the Effective Isotropic Radiated Power (EIRP) of the RU's 108 beam(s), which provides less spatial discrimination (less capacity for spatial multiplexing) and less opportunities to reuse the same time-frequency resources within the same sector. However, this should be tolerable during low traffic periods, due to the reduction in interference from adjacent cells 102, and would reduce power consumption in the RU 108.

The method 1100 proceeds at optional step 1108 (referred to as the third step above) where the RU 108 periodically disables at least one additional antenna 122 used to transmit the wireless signals from the RU 108, along with at least some additional circuitry used to process the wireless signals for the at least one additional antenna 122. The additional circuitry being periodically disabled may include (1) entire receive chain(s) 154 and/or transmit chain(s) 156 processing signals for the disabled at least one antenna 122; or (2) merely low-noise amplifier(s) 148 and/or power amplifier(s) 152 in the receive chain(s) 154 and transmit chain(s) 156, respectively, processing signals for the disabled at least one additional antenna 122; or (3) any combination of components in the receive chain 154 and/or transmit chain 156 processing signals for the disabled at least one additional antenna 122.

Optional step 1108 differs from optional step 1106 in that the at least one antenna 122 (and their associated receive chain(s) 154, transmit chain(s) 156, and/or power amplifiers) are disabled on an extended basis (minutes, hours, days, etc.) in optional step 1106, while the at least one additional antenna 122 (and their additional receive chain(s) 154, transmit chain(s) 156, and/or power amplifiers) are disabled and re-enabled periodically in optional step 1108. For example, in optional step 1108, the at least one additional antenna 122 may be active only (1) during slots containing synchronization signal block (SSB) traffic on the downlink; (2) during random access channel (RACH) periods on the uplink; and/or (3) whenever uplink or downlink traffic (data) is scheduled.

The method 1100 proceeds at optional step 1110 (referred to as the fourth step above) where, for at least one amplifier circuit in the RU 108, the RU 108 limits a voltage bias of a drain and/or a gate of the respective at least one amplifier circuit based on an average amplitude of a signal being transmitted. Optional step 1110 may alternatively be referred to as average power drain control. In other words, the RU 108 detects the average power of a signal being transmitted, then adjusts the drain and/or gate voltage of the at least one amplifier circuit accordingly. For example, as the amplitude of the signal being transmitted is reduced (in response to interference reducing from light traffic), the bias voltage of the drain and/or gate of the at least one amplifier can be reduced proportionally. Therefore, optional step 1110 may reduce unnecessary power dissipation by operating the at least one amplifier at a lower bias. Optional step 1110 may be used to adjust the bias voltage of gate(s) and/or drain(s) in a final power amplifier stage, a pre-amplifier, and/or driver amplifier stage(s) in a transmit chain 156 of an RU 108.

The method 1100 proceeds at optional step 1112 (referred to as the fifth step above) where a speed of at least one fan is reduced or a number of fans in the RU 108 is reduced based on temperature(s) of at least one component in the RU 108 falling below respective threshold(s). For example, the DC voltage applied to fan(s) may be reduced or pulse width modulation may be used to reduce the speed of fan(s).

The methods and techniques described here may be implemented in digital electronic circuitry, field programmable gate array (FPGA), or with a programmable processor (for example, a special-purpose processor or a general-purpose processor such as a computer) firmware, software, or in combinations of them. Apparatus embodying these techniques may include appropriate input and output devices, field programmable gate array (FPGA), a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially designed application-specific integrated circuits (ASICs).

### Terminology

Brief definitions of terms, abbreviations, and phrases used throughout this application are given below.

The term “determining” and its variants may include calculating, extracting, generating, computing, processing, deriving, modeling, investigating, looking up (e.g., looking up in a table, a database, or another data structure), ascertaining and the like. Also, “determining” may also include receiving (e.g., receiving information), accessing (e.g., accessing data in a memory) and the like. Also, “determining” may include resolving, selecting, choosing, establishing and the like.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The terms “connected”, “coupled”, and “communicatively coupled” and related terms may refer to direct or indirect connections. If the specification states a component or feature “may,” “can,” “could,” or “might” be included or have a characteristic, that particular component or feature is not required to be included or have the characteristic.

The terms “responsive” or “in response to” may indicate that an action is performed completely or partially in response to another action. The term “module” refers to a functional component implemented in software, hardware, or firmware (or any combination thereof) component.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

In conclusion, the present disclosure provides novel systems, methods, and arrangements for reducing radio unit power consumption. While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### Example Embodiments

Example 1 includes a base station for reducing power consumption in a radio unit, comprising: at least one processor configured to: trigger at least one power reduction step for the radio unit based on at least one data metric for at least the base station dropping below a threshold; and reduce a number of frequency carriers that the radio unit wirelessly transmits on in response to the at least one power reduction step being triggered.

Example 2 includes the base station of Example 1, wherein the base station is a cloud radio access network (C-RAN) implementing a Fifth Generation New Radio (5G NR) wireless interface, comprising: the radio unit and a plurality of additional radio units, each being configured to exchange radio frequency (RF) signals with at least one user equipment (UE); and a centralized unit communicatively coupled to the radio unit and the plurality of additional radio units via a front-haul network, wherein the centralized unit is a Distributed Unit (DU) or a Central Unit (CU) configured to operate in a 3GPP Fifth Generation communication system.

Example 3 includes the base station of Example 2, wherein the base station utilizes carrier frequencies in a millimeter-wave range of greater than or equal to 24 GHz.

Example 4 includes the base station of any of Examples 1-3, wherein the base station is a cloud radio access network (C-RAN) implementing a 3GPP Fourth Generation (4G) air interface, comprising: a plurality of radio points (RPs), each being configured to exchange radio frequency (RF) signals with at least one user equipment (UE), wherein the radio unit is implemented by one of the RPs; and a baseband controller communicatively coupled to the plurality of RPs via a front-haul network.

Example 5 includes the base station of any of Examples 1-4, wherein the at least one processor is further configured to disable at least one antenna used to transmit wireless signals from the radio unit, along with at least some associated circuitry used to process the wireless signals for the at least one antenna.

Example 6 includes the base station of any of Examples 1-5, wherein the at least one processor is further configured to periodically disable at least one additional antenna used to transmit wireless signals from the radio unit, along with at least some additional circuitry used to process the wireless signals for the at least one additional antenna.

Example 7 includes the base station of Example 6, wherein the at least one processor is further configured to re-enable the at least one additional antenna and the at least some additional circuitry: during slots containing downlink synchronization signal block (SSB) traffic; during random access channel (RACH) periods; and when uplink or downlink user data traffic is scheduled to or from the base station, respectively.

Example 8 includes the base station of any of Examples 1-7, wherein the at least one processor is further configured to, for each of at least one amplifier circuit in the radio unit, limit a voltage bias of a drain, a gate, or both, of the respective amplifier circuit based on an average amplitude of a signal being transmitted.

Example 9 includes the base station of any of Examples 1-8, wherein the at least one processor is further configured to reduce a speed of at least one fan or reduce a number of fans operating in the radio unit based on a respective temperature of at least one component in the radio unit falling below a respective temperature threshold.

Example 10 includes the base station of Example 8, wherein the at least one amplifier circuit comprises one or more of the following: a final power amplifier stage, a pre-amplifier, and one or more driver amplifier stages in a transmit chain of the radio unit.

Example 11 includes the base station of any of Examples 1-10, wherein the at least one data metric comprises data throughput for the base station or a current throughput capacity utilization for the base station.

Example 12 includes a method for reducing power consumption in a radio unit in a base station, comprising: triggering at least one power reduction step for the radio unit based on at least one data metric for at least the base station dropping below a threshold; and reducing a number of frequency carriers that the radio unit wirelessly transmits on in response to the at least one power reduction step being triggered.

Example 13 includes the method of Example 12, wherein the base station is a cloud radio access network (C-RAN) implementing a Fifth Generation New Radio (5G NR) wireless interface, comprising: the radio unit and a plurality of additional radio units, each being configured to exchange radio frequency (RF) signals with at least one user equipment (UE); and a centralized unit communicatively coupled to the radio unit and the plurality of additional radio units via a front-haul network, wherein the centralized unit is a Distributed Unit (DU) or a Central Unit (CU) configured to operate in a 3GPP Fifth Generation communication system.

Example 14 includes the method of Example 13, wherein the base station utilizes carrier frequencies in a millimeter-wave range of greater than or equal to 24 GHz.

Example 15 includes the method of any of Examples 12-14, wherein the base station is a cloud radio access network (C-RAN) implementing a 3GPP Fourth Generation (4G) air interface, comprising: a plurality of radio points (RPs), each being configured to exchange radio frequency (RF) signals with at least one user equipment (UE), wherein the radio unit is implemented by one of the RPs; and a baseband controller communicatively coupled to the plurality of RPs via a front-haul network.

Example 16 includes the method of any of Examples 12-15, further comprising disabling at least one antenna used to transmit wireless signals from the radio unit, along with at least some associated circuitry used to process the wireless signals for the at least one antenna.

Example 17 includes the method of any of Examples 12-16, further comprising periodically disabling at least one additional antenna used to transmit wireless signals from the radio unit, along with at least some additional circuitry used to process the wireless signals for the at least one additional antenna.

Example 18 includes the method of Example 17, further comprising re-enabling the at least one additional antenna and the at least some additional circuitry: during slots containing downlink synchronization signal block (SSB) traffic; during random access channel (RACH) periods; and when uplink or downlink user data traffic is scheduled to or from the base station, respectively.

Example 19 includes the method of any of Examples 12-18, further comprising, for each of at least one amplifier circuit in the radio unit, limiting a voltage bias of a drain, a gate, or both, of the respective amplifier circuit based on an average amplitude of a signal being transmitted.

Example 20 includes the method of any of Examples 12-19, further comprising reducing a speed of at least one fan or reducing a number of fans operating in the radio unit based on a respective temperature of at least one component in the radio unit falling below a respective temperature threshold.

Example 21 includes the method of Example 19, wherein the at least one amplifier circuit comprises one or more of the following: a final power amplifier stage, a pre-amplifier, and one or more driver amplifier stages in a transmit chain of the radio unit.

Example 22 includes the method of any of Examples 12-21, wherein the at least one data metric comprises data throughput for the base station or a current throughput capacity utilization for the base station.

1. A base station for reducing power consumption in a radio unit, comprising:
at least one processor configured to:
trigger at least one power reduction step for the radio unit based on at least one data metric for at least the base station dropping below a threshold; and
reduce a number of frequency carriers that the radio unit wirelessly transmits on in response to the at least one power reduction step being triggered.

2. The base station of claim 1, wherein the base station is a cloud radio access network (C-RAN) implementing a Fifth Generation New Radio (5G NR) wireless interface, comprising:
the radio unit and a plurality of additional radio units, each being configured to exchange radio frequency (RF) signals with at least one user equipment (UE); and
a centralized unit communicatively coupled to the radio unit and the plurality of additional radio units via a front-haul network, wherein the centralized unit is a Distributed Unit (DU) or a Central Unit (CU) configured to operate in a 3GPP Fifth Generation communication system.

3. The base station of claim 2, wherein the base station utilizes carrier frequencies in a millimeter-wave range of greater than or equal to 24 GHz.

4. The base station of claim 1, wherein the base station is a cloud radio access network (C-RAN) implementing a 3GPP Fourth Generation (4G) air interface, comprising:
a plurality of radio points (RPs), each being configured to exchange radio frequency (RF) signals with at least one user equipment (UE), wherein the radio unit is implemented by one of the RPs; and
a baseband controller communicatively coupled to the plurality of RPs via a front-haul network.

5. The base station of claim 1, wherein the at least one processor is further configured to disable at least one antenna used to transmit wireless signals from the radio unit, along with at least some associated circuitry used to process the wireless signals for the at least one antenna.

6. The base station of claim 1, wherein the at least one processor is further configured to periodically disable at least one additional antenna used to transmit wireless signals from the radio unit, along with at least some additional circuitry used to process the wireless signals for the at least one additional antenna.

7. The base station of claim 6, wherein the at least one processor is further configured to re-enable the at least one additional antenna and the at least some additional circuitry:
during slots containing downlink synchronization signal block (SSB) traffic;
during random access channel (RACH) periods; and
when uplink or downlink user data traffic is scheduled to or from the base station, respectively.

8. The base station of claim 1, wherein the at least one processor is further configured to, for each of at least one amplifier circuit in the radio unit, limit a voltage bias of a drain, a gate, or both, of the respective amplifier circuit based on an average amplitude of a signal being transmitted.

9. The base station of claim 1, wherein the at least one processor is further configured to reduce a speed of at least one fan or reduce a number of fans operating in the radio unit based on a respective temperature of at least one component in the radio unit falling below a respective temperature threshold.

10. The base station of claim 8, wherein the at least one amplifier circuit comprises one or more of the following: a final power amplifier stage, a pre-amplifier, and one or more driver amplifier stages in a transmit chain of the radio unit.

11. The base station of claim 1, wherein the at least one data metric comprises data throughput for the base station or a current throughput capacity utilization for the base station.

12. A method for reducing power consumption in a radio unit in a base station, comprising:
triggering at least one power reduction step for the radio unit based on at least one data metric for at least the base station dropping below a threshold; and
reducing a number of frequency carriers that the radio unit wirelessly transmits on in response to the at least one power reduction step being triggered.

13. The method of claim 12, wherein the base station is a cloud radio access network (C-RAN) implementing a Fifth Generation New Radio (5G NR) wireless interface, comprising:
the radio unit and a plurality of additional radio units, each being configured to exchange radio frequency (RF) signals with at least one user equipment (UE); and
a centralized unit communicatively coupled to the radio unit and the plurality of additional radio units via a front-haul network, wherein the centralized unit is a Distributed Unit (DU) or a Central Unit (CU) configured to operate in a 3GPP Fifth Generation communication system.

14. The method of claim 13, wherein the base station utilizes carrier frequencies in a millimeter-wave range of greater than or equal to 24 GHz.

15. The method of claim 12, wherein the base station is a cloud radio access network (C-RAN) implementing a 3GPP Fourth Generation (4G) air interface, comprising:
a plurality of radio points (RPs), each being configured to exchange radio frequency (RF) signals with at least one user equipment (UE), wherein the radio unit is implemented by one of the RPs; and
a baseband controller communicatively coupled to the plurality of RPs via a front-haul network.

16. The method of claim 12, further comprising disabling at least one antenna used to transmit wireless signals from the radio unit, along with at least some associated circuitry used to process the wireless signals for the at least one antenna.

17. The method of claim 12, further comprising periodically disabling at least one additional antenna used to transmit wireless signals from the radio unit, along with at least some additional circuitry used to process the wireless signals for the at least one additional antenna.

18. The method of claim 17, further comprising re-enabling the at least one additional antenna and the at least some additional circuitry:
during slots containing downlink synchronization signal block (SSB) traffic;
during random access channel (RACH) periods; and
when uplink or downlink user data traffic is scheduled to or from the base station, respectively.

19. The method of claim 12, further comprising, for each of at least one amplifier circuit in the radio unit, limiting a voltage bias of a drain, a gate, or both, of the respective amplifier circuit based on an average amplitude of a signal being transmitted.

20. The method of claim 12, further comprising reducing a speed of at least one fan or reducing a number of fans operating in the radio unit based on a respective temperature of at least one component in the radio unit falling below a respective temperature threshold.

21. The method of claim 19, wherein the at least one amplifier circuit comprises one or more of the following: a final power amplifier stage, a pre-amplifier, and one or more driver amplifier stages in a transmit chain of the radio unit.

22. The method of claim 12, wherein the at least one data metric comprises data throughput for the base station or a current throughput capacity utilization for the base station.
